(19) United States
(12) Patent Application Publication
(10) Pub. No.: US 2026/0280805 A1
(43) Pub. Date: Sep. 17, 2026

(54) METHODS, DEVICES AND MEDIUM FOR COMMUNICATION

(71) Applicant: NEC Corporation, Tokyo (JP)

(72) Inventors: Yukai GAO, Beijing (CN); Peng GUAN, Beijing (CN); Gang WANG, Beijing (CN)

(73) Assignee: NEC Corporation, Tokyo (JP)

(21) Appl. No.: 19/168,096

(22) PCT Filed: Mar. 27, 2023
(86) PCT No.: PCT/CN2023/084202

§ 371 Date: Sep. 23, 2025

(51) Int. Cl. H04L 5/00; H04W 72/0446; H04W 72/232

(52) U.S. Cl. CPC H04L 5/0051; H04W 72/0446; H04W 72/232

(57) ABSTRACT

According to embodiments of the present disclosure, a terminal device receives, from a network device, information that indicates at least one set of reference signal resources for a time domain channel property (TDCP) reporting. The terminal device performs the TDCP reporting. The TDCP reporting comprises one or more of: at least one amplitude or at least one phase of a correlation between a first reference signal resource and another reference signal resource. If the TDCP reporting comprises a plurality of amplitudes and/or a plurality of phases, the plurality of amplitudes and/or the plurality of phases is based on correlations between the first reference signal resource and a plurality of second reference signal resources. n this way, it can save signaling overheads.

### FIELDS

Example embodiments of the present disclosure generally relate to the field of communication techniques and in particular, to methods, devices, and medium for measurement reporting.

### BACKGROUND

Several technologies have been proposed to improve communication performances. For example, multi-input multi-output (MIMO) has been proposed. MIMO includes features that facilitate utilization of a large number of antenna elements at base station for both sub-6 GHZ and over-6 GHz frequency bands. In this situation, a plurality of antennas at a transmitter and/or receiver can be used to achieve array and diversity gain instead of capacity gain. In wireless communications, different kinds of measurements are performed and report to network. For example, channel state information (CSI) is the known channel properties of a communication link that is based on the measurements. This information describes how a signal propagates from the transmitter to the receiver and represents the combined effect of, for example, scattering, fading, and power decay with distance. The method is called Channel estimation. The CSI makes it possible to adapt transmissions to current channel conditions, which is crucial for achieving reliable communication with high data rates in multi-antenna systems. Therefore, measurement enhancement is worth studying.

### SUMMARY

In general, embodiments of the present disclosure provide methods, devices and computer storage medium for measurement reporting.

In a first aspect, there is provided a terminal device. The terminal device comprises a processor that is configured to cause the terminal device to: receive, from a network device, information that indicates at least one set of reference signal resources for a time domain channel property (TDCP) report; and transmit the TDCP report, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In a second aspect, there is provided a network device. The network device comprises a processor that is configured to cause the terminal device to: transmit, to a terminal device, information that indicates at least one set of reference signal resources for a time domain channel property (TDCP) report; and receive the TDCP report, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In a third aspect, there is provided a communication method. The method comprises: receiving, at a terminal device and from a network device, information that indicates at least one set of reference signal resources for a time domain channel property (TDCP) report; and transmitting the TDCP report, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In a fourth aspect, there is provided a communication method. The method comprises: transmitting, at a network device and to a terminal device, information that indicates at least one set of reference signal resources for a time domain channel property (TDCP) report; and receiving the TDCP report, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In a fifth aspect, there is provided a computer readable medium having instructions stored thereon, the instructions, when executed on at least one processor, causing the at least one processor to carry out the method according to the third, or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A shows different vectors (basis) in different domains for the transmission;

FIG. 1B illustrates an example communication environment in which example embodiments of the present disclosure can be implemented;

FIG. 2 illustrates a signaling flow of CSI report in accordance with some embodiments of the present disclosure;

FIG. 3 illustrates a schematic diagram of reference signal resources;

FIG. 4A and FIG. 4B illustrate schematic diagrams of reference signal resources in accordance with some embodiments of the present disclosure, respectively;

FIG. 5A and FIG. 5B illustrate schematic diagrams of reference signal resources in accordance with some embodiments of the present disclosure, respectively;

FIG. 6 illustrates a schematic diagram of reference signal resources in accordance with some embodiments of the present disclosure;

FIG. 7A to FIG. 7H illustrate examples for Cumulative Distribution Function (CDF) of values of correlation in accordance with some embodiments of the present disclosure;

FIG. 8 illustrates a flowchart of a method implemented at a terminal device according to some example embodiments of the present disclosure;

FIG. 9 illustrates a flowchart of a method implemented at a network device according to some example embodiments of the present disclosure; and

FIG. 10 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. The term “Channel State Information (CSI)” used herein may refer to channel properties of a communication link. CSI describes how a signal propagate from the transmitter to the receiver and represents the combined effect of, for example, scattering, fading, and power decay with distance. The term “CSI report” may refer to a report that indicate how good or bad the channel is.

As mentioned above, CSI enhancement is worth studying. According to some solutions, it needs to specify CSI reporting enhancement for high/medium UE velocities by exploiting time-domain correlation/Doppler-domain information to assist DL precoding, targeting FR1, as follows: Rel-16/17 Type-II codebook refinement, without modification to the spatial and frequency domain basis; UE reporting of time-domain channel properties measured via CSI-RS for tracking. According to some solutions, the enhancements of CSI acquisition for Coherent-joint transmission (CJT) targeting FR1 and up to 4 TRPs, assuming ideal backhaul and synchronization as well as the same number of antenna ports across TRPs, are specified as follows: Release (Rel)-16/17 Type-II codebook refinement for CJT mTRP targeting FDD and its associated CSI reporting, taking into account throughput-overhead trade-off; sounding reference signal (SRS) enhancement to manage inter-transmission reception point (TRP) cross-SRS interference targeting time domain division (TDD) CJT via SRS capacity enhancement and/or interference randomization, with the constraints that 1) without consuming additional resources for SRS; 2) reuse existing SRS comb structure; 3) without new SRS root sequences. It is noted that the maximum number of CSI-RS ports per resource remains the same as in Rel-17, i.e., 32.

According to some solutions, the enhancements of CSI for a high/medium velocity by exploiting time-domain (TD) correlation and/or doppler-domain (DD) information to assist downlink precoding, targeting frequency range 1 (FR 1) is specified, as follows: Release 16/17 type-II codebook refinement, without modification to the spatial domain (SD) basis and frequency domain (FD) basis and/or UE reporting of TD channel properties (TDCP) measured via CSI-reference signal (RS) for tracking.

It should be understood that although feature(s)/operation(s) are discussed in specific example embodiments separately, unless clearly indicated to the contrary, these feature(s)/operation(s) described in different example embodiments may be used in any suitable combination.

According to some solutions, for the second codebook configuration, there may be Q different bitmaps for indicating the location of the non-zero coefficients. For example, each bitmap may be a 2-dimensional bitmap. In some embodiments, q-th (e.g. q∈{1, 2 . . . . Q}) bitmap may correspond to q-th selected third vector for the CSI report. In some embodiments, (q+1)-th (e.g. q∈{0, 1, . . . . Q−1}) bitmap may correspond to (q+1)-th selected third vector for the CSI report. For example, for each layer with index r, the location of non-zero coefficients corresponding to first vector with index i and/or corresponding to second vector index f may be different for different selected third vectors.

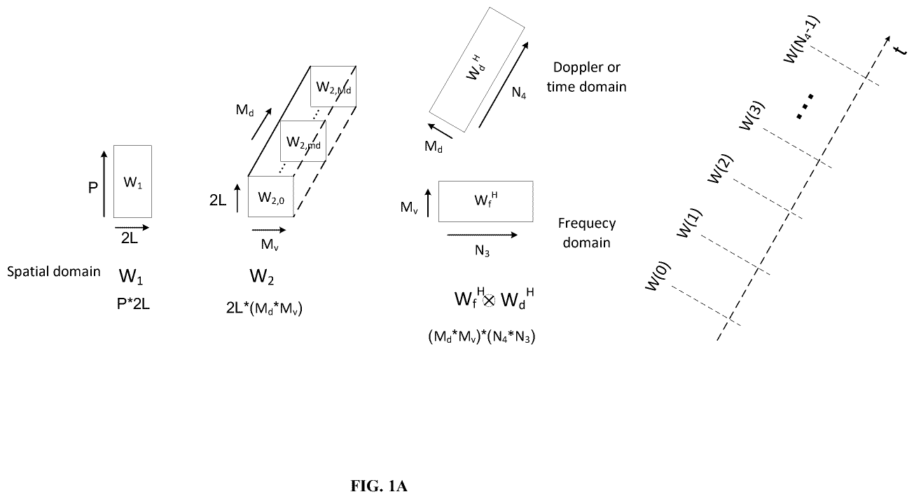

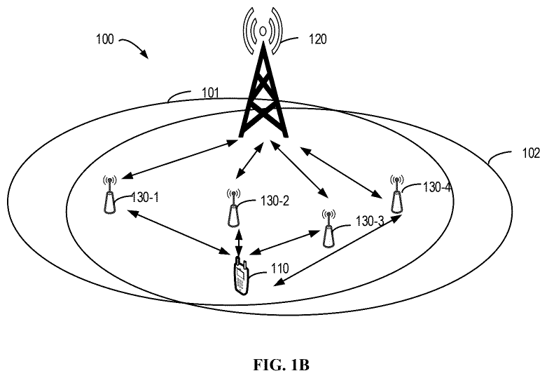

FIG. 1A shows different vectors (basis) in different domains for the transmission. For example, as shown in FIG. 1A, there may be spatial domain, frequency domain and doppler/time domain. The precoding matrix may be: W(n₄)=W₁* [symbol] *(W_{f}⊗W_{d})^{H}, n₄={0, 1, . . . N₄−1}. In this case, W₁ may represent spatial domain basis, W_{f} may represent frequency domain basis, and W_{d} may represent doppler/time domain basis, and [symbol] may represent parameters or coefficients corresponding to the spatial domain basis and/or the frequency domain basis and/or the doppler/time domain basis.

According to some solutions, for aiding gNB determination of codebook switching and sounding reference signal (SRS) periodicity with the Rel-18 tracking reference signal (TRS)-based TDCP reporting, it can support reporting quantized wideband normalized amplitude/phase of the time-domain correlation profile with Y≥1 delay(s) as follows: basic feature: Y=1 with delay≤D_{basic} symbols, only wideband quantized normalized amplitude is reported; optional feature: Y=1 with delay>D_{basic} symbols and Y≥1, wideband quantized normalized amplitude and phase for each delay are reported; and for Y>1, the phase can be configured to be absent for all the Y delays.

In addition, for the Rel-18 TRS-based TDCP reporting, the priority of the CSI report(s) associated with TDCP reporting is down-selected from the following alternatives: Alt1. lower than other CSI reports; Alt2. same as CSI report(s) not carrying layer 1 reference signal received power (L1-RSRP) or layer 1 signal to interference noise ratio (L1-SINR); and Alt3. higher than other CSI reports.

Further, for the Rel-18 TRS-based TDCP reporting, regarding the value of parameter Y for Y>1, down-select from the following alternatives: Alt1. the value of Y is gNB-configured via higher-layer (RRC) signalling; Alt2. the value of Y follows the delays from the configured TRS resource; Alt3. the value of Y is UE-selected and reported. In this case, the value of Y is a UE capability.

In some solutions, for the Rel-18 TRS-based TDCP reporting, for TDCP measurement and calculation, by RAN1 #112bis-e, decide between the following alternatives: Alt1. fully reuse legacy TRS; Alt2. study enhancements on TRS (e.g. periodicities). In some other solutions, for the Rel-18 TRS-based TDCP reporting, it may support multiplexing TDCP reporting with other uplink control information (UCI) parameters on physical uplink shared channel (PUSCH) following the legacy UCI multiplexing rule for aperiodic channel state information (AP-CSI). However, the configuration for TRSC may consume large overhead. Further, it is not clear about the delay for TDCP reporting and the quantization.

In order to solve at least part of the above problems, embodiments of the present disclosure provide a solution on TDCP reporting. According to embodiments of the present disclosure, a terminal device receives, from a network device, information that indicates at least one set of reference signal resources for a time domain channel property (TDCP) reporting. The terminal device performs the TDCP reporting. The TDCP reporting comprises one or more of: at least one amplitude or at least one phase of a correlation between a first reference signal resource and another reference signal resource. If the TDCP reporting comprises a plurality of amplitudes and/or a plurality of phases, the plurality of amplitudes and/or the plurality of phases is based on correlations between the first reference signal resource and a plurality of second reference signal resources. The first reference signal resource is the first one in a first set of reference signal resources or one reference signal resource in a last set of reference signal resources. In this way, signaling overheads can be reduced.

Principles and implementations of the present disclosure will be described in detail below with reference to the figures.

FIG. 1B illustrates a schematic diagram of an example communication environment 100 in which example embodiments of the present disclosure can be implemented. In the communication environment 100, a plurality of communication devices, including a terminal device 110 and a network device 120, can communicate with each other.

In the example of FIG. 1B, the terminal device 110 may be a UE and the network device 120 may be a base station serving the UE. The serving area of the network device 120 may be called a cell 102.

It is to be understood that the number of devices and their connections shown in FIG. 1B are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the terminal device 110 is a terminal device and the network device 120 is a network device, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

For example, the network device 120 may be configured with at least one of four TRPs/panels 130-1, 130-2, 130-3 and 130-4 (collectively referred to as TRPs 130 or individually referred to as TRP 130). It is to be understood that the number of network devices, terminal devices and TRPs as shown in FIG. 1B is only for the purpose of illustration without suggesting any limitations to the present disclosure. The network 100 may include any suitable number of devices adapted for implementing embodiments of the present disclosure. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

It is to be understood that the number of devices and cells in FIG. 1B is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

As shown in FIG. 1B, the network device 120 may communicate with the terminal device 110 via at least one of the TRPs 130-1, 130-2, 130-3 and 130-4. In the following text, the TRP 130-1 may be also referred to as the first TRP, the TRP 130-2 may be also referred to as the second TRP, the TRP 130-3 may be also referred to as the third TRP and the TRP 130-4 may be also referred to as the fourth TRP. Each of the TRPs 130 may provide a plurality of beams for communication with the terminal device 110. It is noted that the number of TRPs shown in FIG. 1B is only an example not limitation.

In some embodiments, the first TRP and/or the second TRP and/or the third TRP and/or the fourth TRP may be explicitly associated with different higher-layer configured identities. For example, a higher-layer configured identity can be associated with a Control Resource Set (CORESET), a reference signal (RS), or a Transmission Configuration Indication (TCI) state, which is used to differentiate between transmissions between different TRPs 130 and the terminal device 110. When the terminal device 110 receives two DCIs in two CORESETs which are associated with different higher-layer configured identities, the two DCIs are indicated from different TRPs. Further, the first and second TRPs 130 may be implicitly identified by a dedicated configuration to the physical channels or signals. For example, a dedicated CORESET, a RS, and a TCI state, which are associated with a TRP, are used to identify a transmission from a different TRP to the terminal device 110. For example, when the terminal device 110 receives a DCI from a dedicated CORESET, the DCI is indicated from the associated TRP dedicated by the CORESET.

In some embodiments, before transmitting data (such as, via the TRP 130-1 and/or 130-2 and/or 130-3 and/or 130-4) to the terminal device 110, the network device 120 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV), as defined in the 3GPP specifications. It is to be understood that the transmission parameters indicated in the control information are not limited to the ones as listed above. Embodiments of the present disclosure may equally be applicable to control information including any transmission parameters.

In the context of the present application, the terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably.

In the context of the present application, the terms “precoding matrix”, “precoding”, “beam”, “beamforming”, “vector”, “first vector”, “first basis”, “first basis vector”, “codebook” and “precoder” may be used interchangeably. The terms “vector”, “bases” and “basis” can be used interchangeably.

In the context of the present application, the terms “single TRP”, “single TCI state”, “single TCI”, “S-TCI”, “single CORESET”, “single control resource set pool”, “S-TRP” and “S-TCI state” can be used interchangeably.

In the context of the present application, the terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

In the context of the present application, the terms “pool”, “set”, “subset”, “group”, “unit” and “subgroup” can be used interchangeably.

In the context of the present application, the terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field”, “bitwidth” and “field size” can be used interchangeably.

In the context of the present application, the terms “first vector”, “a CSI-RS port”, “an antenna port”, “first beam”, “beam”, “first bases”, “first basis vector”, “spatial domain/SD basis vector”, “spatial domain/SD vectors”, “spatial domain/SD basis”, “spatial domain/SD bases”, “spatial domain/SD basis vectors corresponding to a TRP index”, “spatial domain/SD vectors corresponding to a TRP index”, “spatial domain/SD basis corresponding to a TRP index”, “spatial domain/SD bases corresponding to a TRP index”, “first basis corresponding to a TRP index” and “first basis” can be used interchangeably.

In the context of the present application, the terms “second vector”, “second basis”, “frequency domain/FD basis vector”, “frequency domain/FD vector”, “frequency domain/FD basis”, “frequency domain/FD bases”, “second bases”, “second vector corresponding to a TRP index”, “second bases corresponding to a TRP index”, “frequency domain/FD basis vectors corresponding to a TRP index”, “frequency domain/FD vectors corresponding to a TRP index”, “frequency domain/FD basis corresponding to a TRP index”, “frequency domain/FD bases corresponding to a TRP index” and “second basis corresponding to a TRP index” can be used interchangeably.

In the context of the present application, the terms “third vector”, “third bases”, “doppler domain/DD basis vectors”, “doppler domain/DD vectors”, “doppler domain/DD basis”, “doppler domain/DD bases”, “third basis”, “third vector corresponding to a TRP index”, “third bases corresponding to a TRP index”, “doppler domain/DD basis vectors corresponding to a TRP index”, “doppler domain/DD vectors corresponding to a TRP index”, “doppler domain/DD basis corresponding to a TRP index”, “doppler domain/DD bases corresponding to a TRP index”, and “third basis corresponding to a TRP index” can be used interchangeably. In the context of the present application, the terms “doppler domain”, “time domain”, “TD” and “DD” can be used interchangeably.

In the context of the present application, the terms “a TRP”, “a TRP group”, “a CSI-RS resource” and “a group of CSI-RS ports” can be used interchangeably.

In the context of the present application, the terms “refinement” and “enhancement” can be used interchangeably. In the context of the present application, the terms “report” and “feedback” can be used interchangeably.

In the context of the present application, the terms “a first codebook configuration”, ““a first codebook”, “CSI enhancement for CJT”, “Coherent-joint transmission (CJT)”, “Release (Rel)-16/17 Type-II codebook refinement for CJT mTRP”, “Release (Rel)-16/17 Type-II codebook refinement for CJT”, “Release (Rel)-16 Type-II codebook refinement for CJT”, “Release (Rel)-17 Type-II codebook refinement for CJT”, “Type-II codebook refinement for CJT mTRP”, “Type-II codebook refinement for CJT”, “CSI enhancement for CJT”, ““multi-TRP CJT″, “Rel-18 CJT codebook”, ““Rel-18 CJT”, “CJT codebook”, “CJT CSI”, “CSI for CJT” and “CJT CSI enhancement” can be used interchangeably.

In the context of the present application, the terms “a second codebook configuration”, “a second codebook”, “CSI enhancement for high/medium velocity”, “CSI enhancement for velocity”, “codebook enhancement for high/medium velocity”, “codebook enhancement for velocity”, “CSI for high/medium velocity”, “CSI for velocity”, “codebook for high/medium velocity”, “codebook for velocity”, “high/medium velocity”, “velocity”, “CSI feedback with third vector”, “CSI feedback with doppler domain basis”, “CSI feedback with doppler domain vector”, “codebook with third vector”, “codebook with doppler domain basis”, “codebook with doppler domain vector”, “Release (Rel)-16/17 Type-II codebook refinement for high/medium velocity”, “Release (Rel)-16/17 Type-II codebook refinement for velocity”, “Release (Rel)-16 Type-II codebook refinement for velocity”, “Release (Rel)-17 Type-II codebook refinement for velocity”, “Type-II codebook refinement for high/medium velocity”, “Type-II codebook refinement for high/medium velocity”, “CSI enhancement for high/medium velocity”, “Rel-18 high/medium velocity codebook”, “Rel-18 velocity codebook”, “velocity codebook”, “velocity CSI”, “CSI for velocity”, “velocity CSI enhancement”, “high/medium velocity codebook”, “high/medium velocity CSI”, “CSI for high/medium velocity” and “high/medium velocity CSI enhancement” can be used interchangeably.

In the context of the present application, the embodiments described for the first vector may be applied for the second vector and/or for the third vector and/or for the FD basis vector and/or for the SD basis vector and/or for the DD basis vector. In the context of the present application, the embodiments described for the second vector may be applied for the first vector and/or for the third vector and/or for the FD basis vector and/or for the SD basis vector and/or for the DD basis vector.

In the context of the present application, the terms “a TRP index”, “a TRP group index”, “a CSI-RS resource index”, “a group of CSI-RS port indexes” and “a group of CSI-RS ports index” can be used interchangeably.

In the context of the present application, the terms “element of indication field”, “parameter” and “indication” can be used interchangeably.

In the context of the present application, the terms “CSI report”, “CSI reporting”, “CSI report setting”, “CSI feedback”, “codebook”, “codebook configuration”, “codebookConfig” and “CSI” can be used interchangeably.

In the context of the present application, the terms “first type of codebook”, “codebook enhancement based on Rel-16 codebook” and “CSI enhancement based on Rel-16 codebook” can be used interchangeably. In the context of the present application, the terms “second type of codebook”, “codebook enhancement based on Rel-17 codebook” and “CSI enhancement based on Rel-17 codebook” can be used interchangeably.

In the context of the present application, the terms “first mode of codebook structure”, “codebook mode 1”, “codebook mode-1”, “first mode”, “mode 1” and “mode-1” can be used interchangeably. In the context of the present application, the terms “second mode of codebook structure”, “codebook mode 2”, “codebook mode-2”, “second mode”, “mode 2” and “mode-2” can be used interchangeably.

In the context of the present application, the terms “plurality of CSI-RS resources” and “N_{TRP} CSI-RS resources” can be used interchangeably. In the context of the present application, the terms “second plurality of CSI-RS resources” and “N CSI-RS resources” can be used interchangeably. In the context of the present application, the terms “plurality of CSI-RS resources”, “second plurality of CSI-RS resources”, ““selected CSI-RS resources” in the CSI report” and “selected CSI-RS resources” can be used interchangeably.

In the context of the present application, the terms “CSI-RS for tracking”, “tracking CSI-RS”, “CSI-RS for fine time/frequency tracking”, “CSI-RS configured with trs-info” and “TRS” can be used interchangeably. In the context of the present application, the terms “CSI-RS resource for tracking”, “CSI-RS resource configured with trs-info” and “TRS resource” can be used interchangeably. In the context of the present application, the terms “CSI-RS resource set for tracking”, “CSI-RS resource set configured with trs-info”, “a set of CSI-RS resources for tracking”, “a set of CSI-RS resources configured with trs-info”, “a set of TRS resources”, “a set of TRS”, “a TRS set” and “TRS resource set” can be used interchangeably.

In the context of the present application, the terms “delay”, “interval”, “gap” and “lag” can be used interchangeably. In the context of the present application, the terms “TDCP-linking” and “tdcpLinkinID” can be used interchangeably. In the context of the present application, the terms “tdcp-info” and “tdcp-Info” can be used interchangeably. The term “TDCP report” or “TDCP reporting” may refer to information reporting quantized wideband normalized amplitude/phase of the time-domain correlation profile. It is noted the TDCP report or TDCP reporting may include any information that reflect channel properties in time domain.

In addition to normal data communications, the network device 120 may send a RS to the terminal device 110 in a downlink. Similarly, the terminal device 110 may transmit a RS to the network device 120 in an uplink. Generally speaking, a RS is a signal sequence (also referred to as “RS sequence”) that is known by both the network device 120 and the terminal devices 110. For example, a RS sequence may be generated and transmitted by the network device 120 based on a certain rule and the terminal device 110 may deduce the RS sequence based on the same rule. For another example, a RS sequence may be generated and transmitted by the terminal device 110 based on a certain rule and the network device 120 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking, Positioning Reference Signal (PRS) and so on.

In addition to normal data communications, the network device 120 may transmit DCI via a PDCCH to the terminal device 110. The DCI may indicate resource allocation for data transmission in a DL or UL. Concurrently, a DMRS associated with the PDCCH may also be transmitted from the network device 120 to the terminal device 110. The DMRS may be used by the terminal device 110 for channel demodulation. Then, the terminal device 110 may attempt to blindly decode the DCI in a PDCCH in a search space which is associated with a control resource set (CORESET). As used herein, a “CORESET” and/or a search space refers to a set of resource element groups (REGs) within which the terminal device 110 attempts to blindly decode the DCI. A search space indicating the start time and a periodicity for monitoring a PDCCH in the CORESET may be indicated to the terminal device 110. In response to decoding the DCI successfully, the terminal device 110 may perform the UL and/or DL data transmission (for example, data transmission via PDSCH and/or Physical Uplink Shared Channel (PUSCH)) with the network device 120 accordingly.

The network device 120 may communicate data and control information to the terminal device 110 via a plurality of beams (also referred to as “DL beams”). The terminal device 110 may also communicate data and control information to the network device 120 via a plurality of beams (also referred to as “UL beams”). In 3GPP specifications for new radio (NR), a beam is also defined and indicated by parameters of a transmission configuration indicator.

In addition, in the following description, some interactions are performed among the terminal device 110 and the network device 120 (such as, exchanging configuration(s) and so on). It is to be understood that the interactions may be implemented either in one signaling/message/configuration or multiple single signaling/messages/configurations, including system information, radio resource control (RRC) message, downlink control information (DCI) message, uplink control information (UCI) message, media access control (MAC) control element (CE) and so on. The present disclosure is not limited in this regard.

In some embodiments, the terminal device 110 may receive, from the network device, at least one configuration for one CSI report, where the at least one configuration may include at least one of: a plurality of CSI-RS resources for channel measurement for the CSI report, a set of combinations of values for first vector for the CSI report (For example, for the first codebook configuration. For example, the set of combinations of values for first vector may be represented as {Lₜ} with 1<<N or 1<<N_{TRP}. (For example, for the first type of codebook). For another example, the set of combinations of values for first vector may be represented as {αₜ} with 1≤t≤N or 1≤t≤N_{TRP}. (For example, for the second type of codebook). For example, t may be a positive integer), a value for first vector for the CSI report (For example, for the second codebook configuration. For example, the value for first vector may be represented as L (For example, for the first type of codebook). For another example, the value for first vector may be represented as {α} (For example, for the second type of codebook)), at least one value for second vector (e.g. represented as Mᵥ or represented as M) for the CSI report, at least one value for a first parameter (e.g. represented as B) for the CSI report, at least one parameter for antenna port configuration (e.g. a first parameter for antenna port configuration N₁ and a second parameter for antenna port configuration N₂), a type of codebook (For example, the first type of codebook and/or the second type of codebook), a codebook configuration (For example, the first codebook configuration and/or the second codebook configuration), a mode of codebook structure (For example, the first mode of codebook structure and/or the second mode of codebook structure), at least one parameter for codebook, a total number of precoding matrices in the CSI report (e.g. represented as N₃), the number of a plurality of third vectors (e.g. represented as M_{d}), at least one value for a second parameter for codebook (e.g. represented as pᵥ), a third parameter for codebook (e.g. represented as R), the number of a plurality of time units (e.g. represented as N₄), the number of slots of one time unit (e.g. represented as Tᵤ or Tᵢ), and a size of one time unit (e.g. represented as Tᵤ or Tᵢ) and a fourth parameter for codebook (e.g. represented as N_{f}). In some embodiments, the fourth parameter for codebook N_{f} may be configured when the terminal device 110 is configured with second type of codebook. In some embodiments, the fourth parameter for codebook N_{f} may be a size of window for second vectors. In some embodiments, the value of Ne may be at least one of {1,2,4} or {2,4}.

In some embodiments, the terminal device 110 may receive, from the network device, at least one configuration indicating the number of physical resource blocks (PRBs) in a bandwidth part (BWP), the number of a plurality of subbands, a size of one subband, the number of PRBs of one subband, the number of a plurality of time units (e.g. represented as N₄), the number of slots of one time unit (e.g. represented as Tᵤ or Tᵢ), and a size of one time unit (e.g. represented as Tᵤ or Tᵢ). For example, through RRC signalling.

In some embodiments, N₄ may be a positive integer. In some embodiments, N₄ may be at least one of {1,2,3,4, 5, 6, 8, 10, 16, 32} or at least one of {1,2,4,8}. In some embodiments, 1≤N_{4≤32}. In some embodiments, Tᵤ may be a positive integer. In some embodiments, Tᵤ may be at least one of {1,2,3,4, 5, 6, 8, 10, 12,16, 32}. In some embodiments, 1≤Tᵤ≤32 or 1≤Tᵤ≤16.

In some embodiments, the terminal device 110 may be configured with a plurality of CSI-RS resources. In some embodiments, the at least one configuration for the CSI report may comprise or indicate the plurality of CSI-RS resources for channel measurement for the CSI report.

In some embodiments, the number of a plurality of third vectors Q for the CSI report may be at least one of {1,2,3,4,5,6,7,8}. In some embodiments, Q may be a positive integer. In some embodiments, 1≤Q≤8 or 2≤Q≤8 or 2≤Q≤4 or Q=2. In some embodiments, the index for the Q third vectors may be q. In some embodiments, q may be a non-negative integer or a positive integer. In some embodiments, 1≤q≤Q or In some embodiments, 0≤q≤Q−1.

In some embodiments, the terminal device may be configured with the first codebook configuration. In some embodiments, the plurality of CSI-RS resources may comprise N_{TRP} CSI-RS resources. In some embodiments, the plurality of CSI-RS resources may be the N_{TRP} CSI-RS resources. In some embodiments, the number of CSI-RS resources in the plurality of CSI-RS resources may be N_{TRP}. In some embodiments, N_{TRP} may be a positive integer, and 1≤N_{TRP}≤8 or 1<N_{TRP}≤4 or 2≤N_{TRP}≤4. In some embodiments, N_{TRP} may be at least one of {1, 2, 3, 4} or at least one of {2, 3, 4}.

In some embodiments, the terminal device 110 may indicate or select or determine or report a second plurality of CSI-RS resources based on the plurality of CSI-RS resources. In some embodiments, the second plurality of CSI-RS resources may be same as the plurality of CSI-RS resources. In some embodiments, the second plurality of CSI-RS resources may be a subset of the plurality of CSI-RS resources. In some embodiments, the second plurality of CSI-RS resources may comprise N CSI-RS resource. In some embodiments, the second plurality of CSI-RS resources may be N CSI-RS resources. In some embodiments, the number of CSI-RS resources in the second plurality of CSI-RS resources may be N. In some embodiments, N may be a positive integer, and 1≤N≤N_{TRP}. In some embodiments, N may be at least one of {1, 2, 3, 4} or at least one of {2, 3, 4}. In some embodiments, N may be less than or equal to N_{TRP}.

In some embodiments, for the first codebook configuration, the terminal device may be configured with N_{TRP} CSI-RS resources for channel measurement for one CSI report. In some embodiments, N_{TRP} may be a positive integer. In some embodiments, N_{TRP} may be at least one of {1, 2, 3, 4} or {2,3,4}. In some embodiments, the terminal device may be configured based on at least one configuration to determine or select or report N CSI-RS resources from the N_{TRP} CSI-RS resources for channel measurement for one CSI report. In some embodiments, the selection of N CSI-RS resources may be performed by the terminal device. In some embodiments, the selection of N CSI-RS resource may be reported as a part of the one CSI report. In some embodiments, N may be a positive integer. In some embodiments, N may be in a range from 1 to N_{TRP}. In some embodiments, 1<=N<=N_{TRP}. In some embodiments, N may be at least one of {1} or {1, 2} or {1,2,3} or {1,2,3,4}. In some embodiments, N may represent the number of cooperating CSI-RS resources for the CSI report. In some embodiments, N_{TRP} is the maximum number of cooperating CSI-RS resources configured by the network device via higher-layer signaling. In some embodiments, the selection of N out of N_{TRP} CSI-RS resources may be reported via N_{TRP}-bit bitmap in CSI part 1. In some embodiments, a restricted configuration (for example, configured by the network device via higher-layer signaling) may indicate N=N_{TRP} is supposed. For example, N_{TRP}-bit bitmap may not be reported when the restriction or the restricted configuration is configured.

In some embodiments, each CSI-RS resource in the plurality of CSI-RS resources or in the second plurality of CSI-RS resources may be represented as a CSI-RS with index t. In some embodiments, t may be a non-negative integer. For example, 0≤t≤N_{TRP}−1 or 0≤t≤N−1. In some embodiments, t may be a positive integer. For example, 1≤t≤N_{TRP} or 1≤t≤N. In some embodiments, the first CSI-RS resource in the plurality of CSI-RS resources or in the second plurality of CSI-RS resources may be represented as CSI-RS resource with index t=1. In some embodiments, the second CSI-RS resource in the plurality of CSI-RS resources or in the second plurality of CSI-RS resources may be represented as CSI-RS resource with index t=2. In some embodiments, the third CSI-RS resource in the plurality of CSI-RS resources or in the second plurality of CSI-RS resources may be represented as CSI-RS resource with index t=3. In some embodiments, the fourth CSI-RS resource in the plurality of CSI-RS resources or in the second plurality of CSI-RS resources may be represented as CSI-RS resource with index t=4.

In some embodiments, the second plurality of CSI-RS resources may be indicated or reported based on a bitmap in the CSI report. In some embodiments, the number of bits in the bitmap may be N_{TRP}. In some embodiments, a bit in the bitmap may be represented as bₜ, and the value of bₜ may be either 0 or 1. In some embodiments, the bit bₜ in the bitmap may indicate whether the corresponding CSI-RS resource with index t in the plurality of CSI-RS resources selected or not. In some embodiments, the bit bₜ in the bitmap may indicate whether the corresponding CSI-RS resource with index t in the plurality of CSI-RS resources included or selected in the second plurality of CSI-RS resources or not. In some embodiments, the bitmap may be represented as {bₜ}, where 1≤t≤N_{TRP} or 0≤t≤N_{TRP}−1. In some embodiments, a CSI-RS resource with index t in the plurality of CSI-RS resources corresponding to a bit value bₜ is selected or is included in the second plurality of CSI-RS resources if the value bₜ=1. In some embodiments, at least one bit in the bitmap may be with value 1.

In some embodiments, there may be a reference CSI-RS resource in the plurality of CSI-RS resources or in the second plurality of CSI-RS resources. In some embodiments, the reference CSI-RS resource may be a CSI-RS resource corresponding to a strongest coefficient indication or a strongest amplitude coefficient or an indication in the bitmap for non-zero coefficients indication in the CSI report. In some embodiments, the strongest amplitude coefficient or the strongest coefficient indication may be indicated or reported in a field in the CSI report. In some embodiments, the reference CSI-RS resource may be the first one of CSI-RS resource or the last one of CSI-RS resource or the latest one of CSI-RS resource in time in the plurality of CSI-RS resources or the second plurality of CSI-RS resources. In some embodiments, the reference CSI-RS resource may be with index t_{ref}. In some embodiments, t_{ref} may be a positive integer. For example, 1≤t_{ref}≤N_{TRP} or 1≤t_{ref}≤N. In some embodiments, t_{ref} may be a non-negative integer. For example, 0≤t_{ref}≤N_{TRP}−1 or 0≤t_{ref}≤N−1.

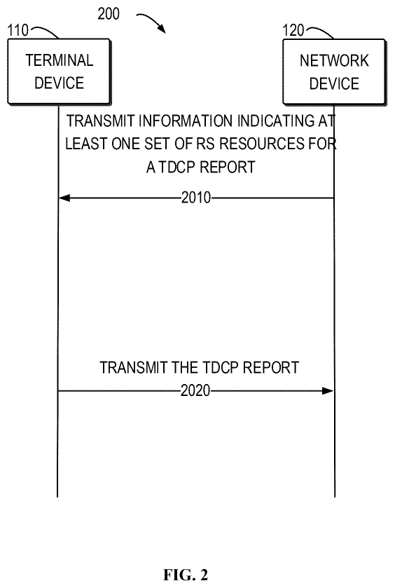

Reference is made to FIG. 2, which illustrates a signaling flow 200 of reporting angle information in accordance with some embodiments of the present disclosure. For the purposes of discussion, the signaling flow 200 will be discussed with reference to FIG. 1B, for example, by using the terminal device 110 and the network device 120. It is noted that FIG. 2 is only an example embodiment.

In some embodiments, the terminal device 110 in RRC connected mode is expected to receive the higher layer UE specific configuration of a NZP-CSI-RS-ResourceSet configured with higher layer parameter trs-Info. For a NZP-CSI-RS-ResourceSet configured with the higher layer parameter trs-Info, the terminal device 110 may assume the antenna port with the same port index of the configured NZP CSI-RS resources in the NZP-CSI-RS-ResourceSet is the same.

In some embodiments, for frequency range 1, the terminal device 110 may be configured with one or more NZP CSI-RS set(s), where a NZP-CSI-RS-ResourceSet consists of four periodic NZP CSI-RS resources in two consecutive slots with two periodic NZP CSI-RS resources in each slot. If no two consecutive slots are indicated as downlink slots by tdd-UL-DL-ConfigurationCommon or tdd-UL-DL-ConfigDedicated, then the UE may be configured with one or more NZP CSI-RS set(s), where a NZP-CSI-RS-ResourceSet consists of two periodic NZP CSI-RS resources in one slot.

In some embodiments, for frequency range 2, the terminal device 110 may be configured with one or more NZP CSI-RS set(s), where a NZP-CSI-RS-ResourceSet consists of two periodic NZP CSI-RS resources in one slot or with a NZP-CSI-RS-ResourceSet consists of four periodic NZP CSI-RS resources in two consecutive slots with two periodic NZP CSI-RS resources in each slot.

In some embodiments, the terminal device 110 may be configured with NZP-CSI-RS-ResourceSet(s) configured with higher layer parameter trs-Info may have the CSI-RS resources configured as:
Periodic, with the CSI-RS resources in the NZP-CSI-RS-ResourceSet configured with same periodicity, bandwidth and subcarrier location.
Periodic CSI-RS resource in one set and aperiodic CSI-RS resources in a second set, with the aperiodic CSI-RS and periodic CSI-RS resource having the same bandwidth (with same resource block (RB) location) and the aperiodic CSI-RS being configured with qcl-Type set to ‘typeA’ and ‘typeD’, where applicable, with the periodic CSI-RS resources. For frequency range 2, the terminal device 110 does not expect that the scheduling offset between the last symbol of the PDCCH carrying the triggering DCI and the first symbol of the aperiodic CSI-RS resources is smaller than beamSwitchTiming+d·2^{μ}^{_{CSIRS}}/2^{μ}^{_{PDCCH}} in CSI-RS symbols, where beamSwitchTiming is the terminal device reported value defined in [13, TS 38.306], the reported value is one of the values of {14, 28, 48}. 2^{max(0,μ}^{_{CSIRS−3)}}, and the beam switching timing delay d is defined in Table 5.2.1.5.1a-1 if μ_{PDCCH}<μ_{CSIRS}, else d is zero. The terminal device 110 shall expect that the periodic CSI-RS resource set and aperiodic CSI-RS resource set are configured with the same number of CSI-RS resources and with the same number of CSI-RS resources in a slot. For the aperiodic CSI-RS resource set if triggered, and if the associated periodic CSI-RS resource set is configured with four periodic CSI-RS resources with two consecutive slots with two periodic CSI-RS resources in each slot, the higher layer parameter aperiodicTriggeringOffset indicates the triggering offset for the first slot for the first two CSI-RS resources in the set.

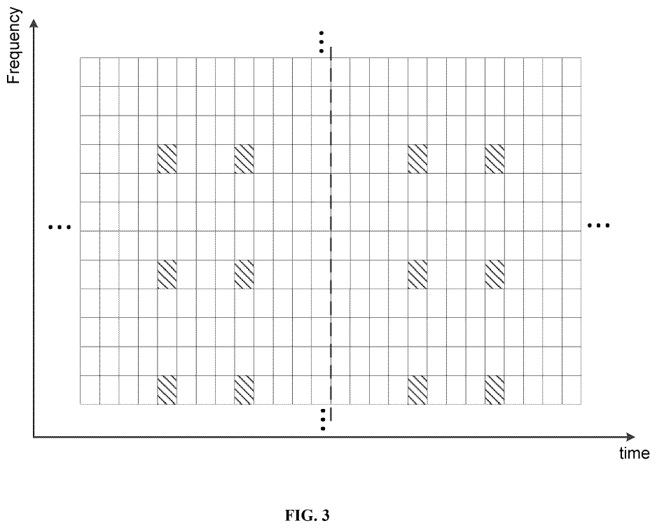

In some embodiments, each CSI-RS resource is configured by the higher layer parameter NZP-CSI-RS-Resource with the following restrictions: —the time-domain locations of the two CSI-RS resource in a slot, or of the four CSI-RS resources in two consecutive slots (which are the same across two consecutive slots, for example, as shown in FIG. 3), as defined by higher layer parameters CSI-RS-resourceMapping, is given by one of: −l∈{4,8}, l∈{5, 9}, or l∈{6, 10} for frequency range 1 and frequency range 2; −l∈{0,4}, l∈{1,5}, l∈{2, 6}, l∈{3, 7}, l∈{7, 11}, l∈{8, 12}, or l∈{9, 13} for frequency range 2; —a single port CSI-RS resource with density ρ=3 give by Table 7.4.1.5.3-1 from [4, TS 38.211] and higher layer parameter density configured by CSI-RS-ResourceMapping.

In some embodiments, if carrier

$${N}_{g r i d}^{s i z e , μ} = 52 , {N}_{B W P , i}^{s i z e} = 52 ,$$

μ=0 and the carrier is configured in paired spectrum, the bandwidth of the CSI-RS resource, as given by the higher layer parameter freqBand configured by CSI-RS-ResourceMapping, is X resource blocks, where X≥28 resource blocks if the terminal device 110 indicates trs-AddBW-Set1 for the trs-AdditionalBandwidth capability for CSI-RS for tracking or addBW-Set1 for the aperiodicCSI-RS-AdditionalBandwidth capability for aperiodic CSI-RS for fast SCell activation and X≥32 if the terminal device 110 indicates trs-AddBW-Set2 for the AdditionalBandwidth capability for CSI-RS for tracking or addBW-Set2 for the aperiodicCSI-RS-AdditionalBandwidth capability for aperiodic CSI-RS for fast SCell activation; in these cases, if the terminal device 110 is configured with CSI-RS comprising X<52 resource blocks, the terminal device 110 does not expect that the total number of PRBs allocated for DL transmissions but not overlapped with the PRBs carrying CSI-RS for tracking is more than 4, where all CSI-RS resource configurations shall span the same set of resource blocks; otherwise, the bandwidth of the CSI-RS resource, as given by the higher layer parameter freqBand configured by CSI-RS-ResourceMapping, is the minimum of 52 and

$${N}_{B W P , i}^{s i z e}$$

resource blocks, or is equal to

$${N}_{B W P , i}^{s i z e}$$

resource blocks. For operation with shared spectrum channel access in FR1, freqBand configured by CSI-RS-ResourceMapping, is the minimum of 48 and

$${N}_{B W P , i}^{s i z e}$$

resource blocks, or is equal to

$${N}_{B W P , i}^{s i z e}$$

resource blocks.

In some embodiments, the terminal device 110 is not expected to be configured with the periodicity of 2^{μ}×10 slots if the bandwidth of CSI-RS resource is larger than 52 resource blocks.

In some embodiments, the periodicity and slot offset for periodic NZP CSI-RS resources, as given by the higher layer parameter periodicityAndOffset configured by NZP-CSI-RS-Resource, is one of 2^{μ}Xₚ slots where Xₚ=10, 20, 40, or 80. In some embodiments, u may be the subcarrier spacing or numerology parameter. In some embodiments, u may be at least one of {0,1,2,3,4,5,6}. In some embodiments, u may be the subcarrier spacing or numerology parameter, and associated with or correspond to subcarrier spacing (For example, Δf) with value 2^{μ}*15 kHz. In some embodiments, μ=0 may be associated with or correspond to subcarrier spacing (For example, Δf) with value 2° *15 kHz or 15 kHz. In some embodiments, μ=1 may be associated with or correspond to subcarrier spacing (For example, Δf) with value 2¹*15 kHz or 30 kHz. In some embodiments, μ=2 may be associated with or correspond to subcarrier spacing (For example, Δf) with value 2²*15 kHz or 60 kHz. In some embodiments, μ=3 may be associated with or correspond to subcarrier spacing (For example, Δf) with value 2³*15 kHz or 120 kHz. In some embodiments, μ=4 may be associated with or correspond to subcarrier spacing (For example, Δf) with value 2⁴*15 kHz or 240 kHz. In some embodiments, μ=5 may be associated with or correspond to subcarrier spacing (for example, Δf) with value 2⁵*15 kHz or 480 kHz. In some embodiments, μ=6 may be associated with or correspond to subcarrier spacing (For example, Δf) with value 2⁶*15 kHz or 960 kHz.

In some embodiments, same powerControlOffset and powerControlOffsetSS given by NZP-CSI-RS-Resource value across all resources.

The network device 120 transmits (2010) information that indicates at least one set of reference signal resources for a time domain channel property (TDCP) report to the terminal device 110. In other words, the terminal device 110 receives the information that indicates the at least one set of reference signal resources for the TDCP reporting from the network device 120. In this way, the signaling overhead can be saved.

In some embodiments, the reference signal may be a TRS. Alternatively, the reference signal may be CSI-RS. It is noted that the terms “TRS resource set”, “CSI-RS resource set configured with trs-Info”, “a set of TRS” and “a TRS set” can be used interchangeably.

In some embodiments, the terminal device 110 transmits (2020) the TDCP report to the network device 120. The TDCP report comprises one or more of: at least one amplitude or at least one phase of a correlation between a first reference signal resource and another reference signal resource. If the TDCP report comprises a plurality of amplitudes and/or a plurality of phases, the plurality of amplitudes and/or the plurality of phases is based on correlations between the first reference signal resource and a plurality of second reference signal resources. The first reference signal resource is the first one in a first set of reference signal resources or one reference signal resource in a last set of reference signal resources. In some embodiments, the one reference signal resource in the last set of reference signal resources may be the first reference signal resource or the last reference signal resource in the last set of reference signal resources. In this way, it is more suitable for curve fitting.

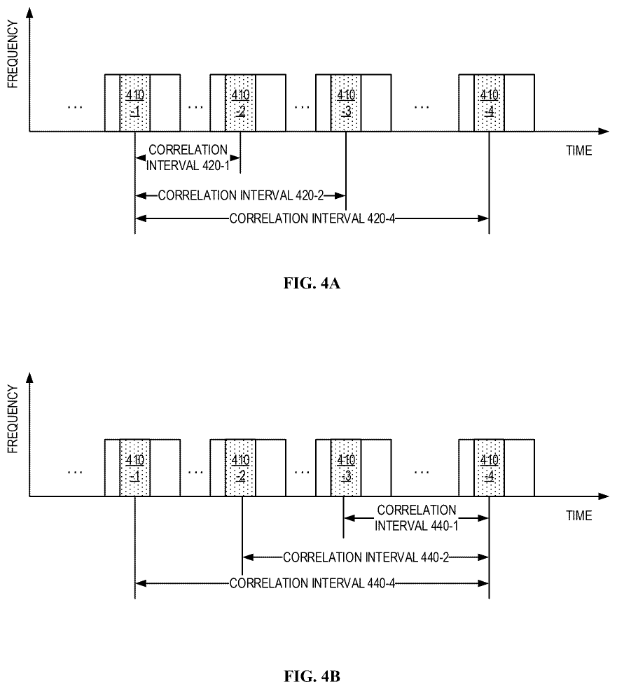

In some embodiments, the information may indicate a first set of reference signal resources and at least one second set of reference signal resources for the TDCP reporting. In some embodiments, as shown in FIG. 4A and FIG. 4B, the set of reference signal resources for the TDCP may include the reference signal resources 410-1, 410-2, 410-3, and 410-4. It is note that the number of reference signal resources shown in FIG. 4A and FIG. 4B is only an example not limitation.

In some embodiments, if there is more than one amplitude or/and more than one phase, the more than one amplitude or/and more than one phase may be based on correlation between a first CSI-RS resource (a fixed CSI-RS) and more than one second CSI-RS resource. Each correlation may be between the first CSI-RS resource and another CSI-RS resource. For example, as shown in FIG. 4A, the first CSI-RS resource may be the first one (for example, the reference signal resource 410-1) in the first set of TRS. As shown in FIG. 4A, there may be a correlation interval 420-1 between the reference signal resource 410-1 and the reference signal resource 410-2, a correlation interval 420-2 between the reference signal resource 410-1 and the reference signal resource 410-3, and a correlation interval 420-3 between the reference signal resource 410-1 and the reference signal resource 410-3. In this case, the TDCP reporting may include at least one amplitude or/and at least one phase of the correlations between the reference signal resource 410-1 and each of the reference signal resources 410-2, 410-3 and 410-4, respectively. In this way, there is only one symbol (resource) of TRS buffered for correlation.

In some other embodiments, as shown in FIG. 4B, the first CSI-RS resource may be the one or last one (for example, the reference signal resource 410-4) in the last set of TRS. As shown in FIG. 4B, there may be a correlation interval 440-1 between the reference signal resource 410-4 and the reference signal resource 410-3, a correlation interval 440-2 between the reference signal resource 410-4 and the reference signal resource 410-2, and a correlation interval 440-3 between the reference signal resource 410-4 and the reference signal resource 410-1. In this case, the TDCP reporting may include at least one amplitude or/and at least one phase of the correlations between the reference signal resource 410-4 and each of the reference signal resources 410-3, 410-2 and 410-1, respectively. In this way, it can reflect latest channel property for a given report, while multiple symbols/resources need to be buffered.

In some embodiments, the first set of reference signal resources is a first set of periodic reference signal resources and the at least one second set of reference signal resources is at least one set of aperiodic reference signal resources. In this case, each one of the at least one set of aperiodic reference signal resources comprises one or two aperiodic reference signal resources in one slot, and the one or two aperiodic reference signal resources have same subcarrier location as reference signal resources in the first set of periodic reference signal resources. For example, the terminal device 110 may be configured with a first set of periodic TRS and at least one set of aperiodic TRS (e.g. a second set of aperiodic TRS) for TDCP reporting. In some embodiments, the first set of TRS may include four periodic CSI-RS resources in two consecutive slots with two CSI-RS resources in each slot or comprises two periodic CSI-RS resources in one slot (e.g. if no two consecutive slots are indicated as downlink slots by tdd-UL-DL-ConfigurationCommon or tdd-UL-DL-ConfigDedicated). In some embodiments, each one of the at least one set of aperiodic TRS may comprise one or two aperiodic CSI-RS resources in one slot, and the one or two aperiodic CSI-RS resources have same subcarrier location as the CSI-RS resources in the first set. In addition, the one or two aperiodic CSI-RS resources in each one of the at least one set may have same symbol location as the first and/or second CSI-RS resources (or the first one or two CSI-RS resources in the first slot) in the first set. In some embodiments, the delay(s) for TDCP reporting comprises the slot offset between the first slot (or second slot) of the first set of periodic TRS and the first slot (or second slot) of each one of the at least one set of aperiodic TRS. For example, the slot offset may be at least one of: 1, 2, 4, 8, 10. For another example, the slot offset may be at least one of: {0.5, 1, 2, 3, 4, 5, 6, 7, 8, 9, 10}.

In some embodiments, the triggering offset (e.g. aperiodicTriggeringOffset) may indicate the slot offset between the first (or second) slot of one occasion the first set and the slot for the second set, the candidate values for the slot offset may be the candidate values for delay for TDCP reporting. The occasion of the first set may be the one nearest to the DCI triggering the report or nearest to the aperiodic TDCP report. The at least one set of TRS for TDCP reporting satisfies CSI reference resource and/or after the DCI triggering the report.

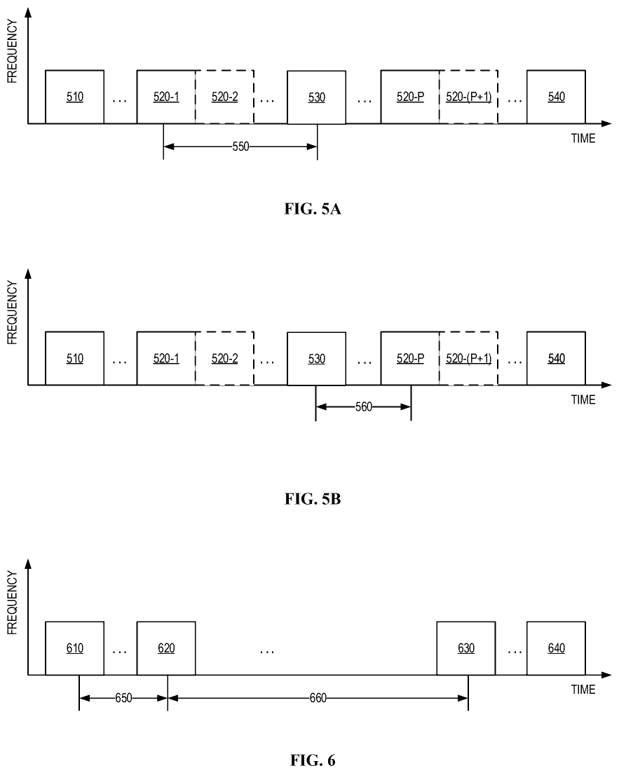

By way of example, in some embodiments, a triggering offset may indicate a slot offset between a first slot of one occasion in the first set of periodic reference signal resources and a slot for the at least one aperiodic set of reference signal resources. For example, as shown in FIG. 5A, downlink control information (DCI) transmitted in slot 510 may schedule the TDCP reporting that is transmitted in slot 540. In some embodiments, the first periodic reference signal resource set may comprise two resources in one slot or four resources in two consecutive slots. By way of example, the first periodic reference signal resource set may include two resources in the slot 520-1 or four resources in the slots 520-1 and 520-2. In addition, the first periodic reference signal resource set may further include two resources in the slot 520-P or four resources in slots 520-P and 520-(P+1). The second aperiodic reference signal resource set may include resource in the slot 530. In this case, the trigger offset indicates the slot offset 550 between the slot 520-1 and the slot 530. In some other embodiments, the triggering offset may indicate the slot offset between a second slot of one occasion in the first set of periodic reference signal resources and the slot for the at least one aperiodic set of reference signal resources. For example, as shown in FIG. 5B, the trigger offset indicates the slot offset 560 between the slot 530 and the slot 520-P. It is note that the number of reference signal resources and the number of slots shown in FIG. 5A and FIG. 5B are only examples not limitations.

In some other embodiments, each one of the at least one set of aperiodic reference signal resources comprises two or four aperiodic reference signal resources in two consecutive slots, and one or two aperiodic reference signal resources in one slot, and the two or four aperiodic reference signal resources have same subcarrier location as the reference signal resources in the first set of periodic reference signal resources. By way of example, the two or four aperiodic CSI-RS resources in each one of the at least one set have same symbol location as the first and/or second CSI-RS resources (or the first one or two CSI-RS resources in the first slot) in the first set. In some embodiments, the delay(s) for TDCP reporting comprises the slot offset between the first slot (or second slot) of the first set of periodic TRS and the first slot of each one of the at least one set of aperiodic TRS, and comprises the slot offset between the first slot (or second slot) of the first set of periodic TRS and the second slot of each one of the at least one set of aperiodic TRS. For example, the slot offset may be at least one of: 1, 2, 3, 4, 5, 8, 10.

In some embodiments, each one of the at least one set of aperiodic reference signal resources is associated with the first set of periodic reference signal resources. In some embodiments, the aperiodic reference signal resource is configured with qcl-Type set to ‘typeA’ (For example, except for quasi co-location parameters {Doppler shift, Doppler spread}) and/or ‘typeD’, with the periodic reference signal resources in the first set. For example, association based on QCL relationship, the aperiodic CSI-RS resource(s) in the at least one set of AP TRS is configured with qcl-Type set to ‘typeA’ (For example, except for quasi co-location parameters {Doppler shift, Doppler spread}) and/or ‘typeD’, where applicable, with the periodic CSI-RS resources in the first set.

In some embodiments, an antenna port with a same port index of configured reference signal resources in the at least one set of aperiodic reference signal resources and in the first set of periodic reference signal resources is the same. For example, the terminal device 110 may assume the antenna port with the same port index of the configured CSI-RS resources in the at least one set of aperiodic TRS and in the first set of periodic TRS is the same. The first set of periodic TRS and the at least one set of aperiodic TRS may be configured to be associated for TDCP reporting (e.g. with a same value of TDCP-linking or with tdcp-info).

In some embodiments, antenna port in the at least one set of reference signal resources and in the first set of reference signal resources may be assumed to be same. In some embodiments, antenna port in the at least one set of aperiodic reference signal resources and in the first set of periodic reference signal resources may be assumed to be same. In some embodiments, antenna port in the at least one set of periodic reference signal resources and in the first set of periodic reference signal resources may be assumed to be same. In some embodiments, antenna port in the at least one set of aperiodic reference signal resources and in the first set of aperiodic reference signal resources may be assumed to be same. In some embodiments, antenna port in the at least one set of aperiodic reference signal resources may be assumed to be same. In some embodiments, antenna port in the set of periodic reference signal resources may be assumed to be same. In some embodiments, antenna port in the first group of reference signal resources and the second group of reference signal resources in set of periodic reference signal resources may be assumed to be same.

In some embodiments, the aperiodic reference signal resource in the at least one set of aperiodic reference signal resources is configured with qcl-Type set to ‘typeC’ (For example, except for quasi co-location parameters {Doppler shift}) and/or ‘typeD’ with a same synchronization signal physical broadcast channel block (SSB) index or a same reference signal resource with quasi colocation (QCL) source reference signal of reference signal resources in the first set of periodic reference signal resources. For example, the aperiodic CSI-RS resource(s) in the at least one set is configured with qcl-Type set to ‘typeC’ (For example, except for quasi co-location parameters {Doppler shift}) and/or ‘typeD’, where applicable, with same SSB index or same CSI-RS resource with QCL source RS of CSI-RS resources in the first set.

In some embodiments, a triggering offset may indicate a slot offset between downlink control information and a slot for the at least one aperiodic set of reference signal resources. In this case, the offset between the slot for the at least one aperiodic set of reference signal resources and a first or second slot of an occasion of the first set of periodic reference signal resources may be one of candidate values for delays supported for the TDCP reporting. By way of example, the triggering offset (e.g. aperiodicTriggeringOffset) indicates the slot offset between the DCI and the slot for the second set, and the offset between the slot for the second set and the first or second slot of the occasion of the first set is assumed to be one of the candidate values for delays supported for TDCP reporting. The occasion of the first set may be the one nearest to the DCI triggering the report or nearest to the aperiodic TDCP report. The at least one set of TRS for TDCP reporting satisfies CSI reference resource and/or after the DCI triggering the report.

In some embodiments, the first set of reference signal resources is a first set of aperiodic reference signal resources and the at least one second set of reference signal resources is at least one set of aperiodic reference signal resources. In this case, in some embodiments, each set of aperiodic reference signal resources comprises one or two aperiodic reference signal resources in one slot, and the aperiodic reference signal resources have same subcarrier location in the at least one set of aperiodic reference signal resources. In some embodiments, the at least one set of aperiodic reference signal resource is associated with a same periodic reference signal resource set.

By way of example, the terminal device 110 may be configured with at least one set of aperiodic TRS for TDCP report. In this case, each set of aperiodic TRS comprises one or two aperiodic CSI-RS resources in one slot, and the aperiodic CSI-RS resources have same subcarrier location in the at least one set. In addition, aperiodic CSI-RS resources in the at least one set may have same symbol location. The at least one set of aperiodic TRS may be associated with a same periodic TRS set. For example, association based on QCL relationship, the aperiodic CSI-RS resource(s) in the at least one set is configured with qcl-Type set to ‘typeA’ (For example, except for quasi co-location parameters {Doppler shift, Doppler spread}) and/or ‘typeD’, where applicable, with the periodic CSI-RS resources in the first set, for example new type QCL. Alternatively, the terminal device 110 may assume the antenna port with the same port index of the configured CSI-RS resources in the at least one set of aperiodic TRS is the same. The at least one set of aperiodic TRS may be configured to be associated for TDCP reporting (e.g. with a same value of TDCP-linking or with tdcp-info or with same CSI-AperiodicTrigger State).

In some embodiments, the terminal device 110 may indicate/report capability to indicate whether to support TDCP reporting or whether to support to be configured with ‘tdcp-Info’ or ‘tdcpLinkingID’.

In some embodiments, the terminal device 110 may be configured with at least one set of CSI-RS resources for TDCP reporting as Table 1 below.

TABLE 1

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-Re- |

sourcesPerSet)) OF NZP-CSI-RS-ResourceId,

| | | |
|---|---|---|
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |
| tdcp-Info | ENUMERATED {true} | OPTIONAL, -- Need R |

...,
[[

| | | |
|---|---|---|
| aperiodicTriggeringOffset-r16 | INTEGER(0..31) | OPTIONAL -- Need S |

```
  ]],
  [[
```

| | | |
|---|---|---|
| pdc-Info-r17 | ENUMERATED {true} | OPTIONAL, -- Need R |
| cmrGroupingAndPairing-r17 | CMRGroupingAndPairing-r17 | OPTIONAL, -- |

Need R

| | | |
|---|---|---|
| aperiodicTriggeringOffset-r17 | INTEGER (0..124) | OPTIONAL, -- Need S |
| aperiodicTriggeringOffsetL2-r17 | INTEGER(0..31) | OPTIONAL -- Need R |

]]
}
tdcp-Info
Indicates that the antenna port for all NZP-CSI-RS resources in the CSI-RS resource set is
same. If the field is absent or released the UE applies the value false.

In some embodiments, the field tdcp-Info may indicate the CSI-RS resource set is configured for TDCP reporting. In some embodiments, the field tdcp-info present or configured with ‘true’ may be conditioned on when the field trs-Info is present or configured with ‘true’. In some embodiments, the field tdcp-Info present or configured with ‘true’ may not be configured simultaneously when the field trs-Info is present or configured with ‘true’. In some embodiments, the field tdcp-Info can be present or configured to be ‘true’ only if trs-Info is present or configured with ‘true’. In some embodiments, if the terminal device 110 is configured the field for tdcp-Info at least one set of CSI-RS resources, the terminal device 110 may measure TDCP based on the at least one set of CSI-RS resources.

In some embodiments, the terminal device 110 may be configured with at least one set of CSI-RS resources for TDCP reporting as Table 2 below.

TABLE 2

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-Re- |

sourcesPerSet)) OF NZP-CSI-RS-ResourceId,

| | | |
|---|---|---|
| repetition | ENUMERATED { on, off } | OPTIONAL, -- Need S |
| aperiodicTriggeringOffset | INTEGER(0..6) | OPTIONAL, -- Need S |
| trs-Info | ENUMERATED {true} | OPTIONAL, -- Need R |
| tdcpLinkingID | Integer (0...X} or ENUMERATED {true} | Conditioned on trs- |

Info
...,
[[

| | | |
|---|---|---|
| aperiodicTriggeringOffset-r16 | INTEGER(0..31) | OPTIONAL -- Need S |

```
  ]],
  [[
```

| | | |
|---|---|---|
| pdc-Info-r17 | ENUMERATED {true} | OPTIONAL, -- Need R |
| cmrGroupingAndPairing-r17 | CMRGroupingAndPairing-r17 | OPTIONAL, -- |

Need R

| | | |
|---|---|---|
| aperiodicTriggeringOffset-r17 | INTEGER (0..124) | OPTIONAL, -- Need S |
| aperiodicTriggeringOffsetL2-r17 | INTEGER(0..31) | OPTIONAL -- Need R |

]]
}

In some embodiments, X may be a non-negative integer. For example, 0<=X<=64. In some embodiments, X may be ‘true’.

In some embodiments, the field tdcpLinkinID may indicate the CSI-RS resource set is configured for TDCP reporting. In some embodiments, the field tdcpLinkinID present or configured with ‘true’ may be conditioned on when the field trs-Info is present or configured with ‘true’. In some embodiments, the field tdcpLinkinID present or configured with ‘true’ may not be configured simultaneously when the field trs-Info is present or configured with ‘true’. In some embodiments, the field tdcpLinkinID can be present or configured to be ‘true’ only if trs-Info is present or configured with ‘true’. In some embodiments, if the terminal device 110 is configured the field for tdcpLinkinID at least one set of CSI-RS resources, the terminal device 110 may measure TDCP based on the at least one set of CSI-RS resources. In some embodiments, the field tdcpLinkinID may be used to link at least two sets of CSI-RS resources. For example, for TDCP reporting. For example, in the same bandwidth part (BWP). In some embodiments, if at least two sets of CSI-RS resources have the same tdcpLinkinID, the terminal device 110 may assume these sets of CSI-RS resources are linked/applied/used for TDCP reporting.

In some embodiments, a triggering offset for the first set indicates a first slot offset between DCI and a slot for the first set, and the triggering offset for the second set indicates a second slot offset between the slot of the first set and a slot for the second set, candidate values for the second slot offset are candidate values for delay for the TDCP report. For example, as shown in FIG. 6, DCI transmitted in slot 610 may schedule the TDCP REPORT that is transmitted in slot 640. As shown in FIG. 6, the first TRS set may be in slot 620 and the second TRS set may be in slot 630. The triggering offset for the first set may indicate the slot offset 650 between the DCI in the slot 610 and the slot 620 of the first set. The triggering offset for the second set may indicate the slot offset 660 between the slot 620 of the first set and the slot 630 for the second set. By way of example, the triggering offset (e.g. aperiodicTriggeringOffset) for the first set indicates a first slot offset between the DCI and the slot for the first set, and the triggering offset (e.g. aperiodicTriggeringOffset) for the other sets (e.g. the second set) indicates a second slot offset between the slot of the first set and the slot for the second set, the candidate values for the second slot offset may be the candidate values for delay for TDCP report. The at least one set of TRS for TDCP reporting may satisfy CSI reference resource and/or after the DCI triggering the report. In this case, the first set may be the TRS set with lowest (or highest) resource set ID.

In some embodiments, the triggering offset for each set of reference signal resources indicates a slot offset between DCI and a slot for a corresponding set, and candidate values for the slot offset are candidate values for delay for the TDCP report. In addition, the offset between a slot for the second set and a slot of the first set may be one of the candidate values for delays supported for the TDCP report. For example, the triggering offset (e.g. aperiodicTriggeringOffset) for each set of TRS indicates the slot offset between the DCI and the slot for the corresponding set, and, the candidate values for the slot offset may be the candidate values for delay for TDCP reporting, and the offset between the slot for the second set and the slot of the first set is assumed to be one of the candidate values for delays supported for TDCP reporting.

In some embodiments, the first set of reference signal resources is a first set of periodic reference signal resources and the at least one second set of reference signal resources is a second set of periodic reference signal resources. In some embodiments, the second set of periodic reference signal resources comprises one or two aperiodic reference signal resources in one slot, and one or two periodic reference signal resources have same subcarrier location as the reference signal resources in the first set of periodic reference signal resources. By way of example, the terminal device 110 may be configured with at least one set of periodic TRS for TDCP reporting (e.g. a first set and a second set). For example, the first set of TRS (as legacy configuration) comprises four periodic CSI-RS resources in two consecutive slots with two CSI-RS resources in each slot or comprises two periodic CSI-RS resources in one slot (e.g. if no two consecutive slots are indicated as downlink slots by tdd-UL-DL-ConfigurationCommon or tdd-UL-DL-ConfigDedicated). The second set of periodic TRS may include one or two aperiodic CSI-RS resources in one slot, and the one or two periodic CSI-RS resources have same subcarrier location as the CSI-RS resources in the first set. In addition, the one or two periodic CSI-RS resources in the second set have same symbol location as the first and/or second CSI-RS resources (or the first one or two CSI-RS resources in the first slot) in the first set.

In some embodiments, the second set of periodic reference signal resources is associated with the first set of periodic reference signal resources. For example, the second set of periodic TRS may be associated with the first set of periodic TRS. By way of example, association based on QCL relationship, the periodic CSI-RS resource(s) in the at least one second set is configured with qcl-Type set to ‘typeA’ (For example, except for quasi co-location parameters {Doppler shift, Doppler spread}) and/or ‘typeD’, where applicable, with the periodic CSI-RS resources in the first set. Alternatively, the terminal device 110 may assume the antenna port with the same port index of the configured CSI-RS resources in the at least one second set of periodic TRS and in the first set of periodic TRS is the same. The first set of periodic TRS and the at least one second set of periodic TRS may be configured to be associated for TDCP reporting (e.g. with a same value of TDCP-linking or with tdcp-info). In some other embodiments, the periodic CSI-RS resource(s) in the at least one second set is configured with qcl-Type set to ‘typeC’ (For example, except for quasi co-location parameters {Doppler shift}) and/or ‘typeD’, where applicable, with same SSB index or same CSI-RS resource with QCL source RS of CSI-RS resources in the first set.

The slot offset between two adjacent TRS sets (e.g. first slot of first set to first slot of second set or first slot of first set to second slot of second set or second slot of first set to first slot of second set or second slot of first set to second slot of second set) may be assumed to be one of the candidate values for delays supported for TDCP reporting. In other words, for periodic and semi-persistent CSI Resource Settings, when the UE is configured with groupBasedBeamReporting-r17, the number of CSI Resource Sets configured is S=2, or when the UE is configured with tdcpReporting, the number of CSI Resource Sets configured is S=M (e.g. M may be 2 or 3 or 4), otherwise the number of CSI-RS Resource Sets configured is limited to S=1.

In some embodiments, the information indicates at least one set of periodic reference signal resources for the TDCP report. By way of example, the terminal device 110 may be configured with one set of periodic TRS for the TDCP report. In this case, the set of TRS may include X periodic CSI-RS resources (X may be 3, 4, 5, 6, 7, 8, 12, 16), and the X periodic CSI-RS resources may be divided into M groups (e.g. M may be 2 or 3 or 4). For example, in the first group, there may be four periodic CSI-RS resources in first two consecutive slots with two CSI-RS resources in each slot or there may be two periodic CSI-RS resources in a first slot (e.g. if no two consecutive slots are indicated as downlink slots by tdd-UL-DL-ConfigurationCommon or tdd-UL-DL-ConfigDedicated), and in the second group, there may be one or two periodic CSI-RS resources in a second slot, where the offset between the second slot and the first slot (or a first one of the first two consecutive slots) may be assumed to be one of the candidate values for delays supported for TDCP reporting. The CSI-RS resources in the first group is configured with a same periodicity (e.g. a first periodicity), and the CSI-RS resource(s) in the second group is configured with a second periodicity, and the second periodicity may be different from the first periodicity (e.g. larger than the first periodicity, as a multiple of the first periodicity).

In some embodiments, one or two periodic reference signal resources in a second group of the at least one set of periodic reference signal resources for the TDCP report have same subcarrier location as reference signal resources in a first group of the at least one set of periodic reference signal resources for the TDCP report. The one or two periodic CSI-RS resources in the second group may have same subcarrier location as the CSI-RS resources in the first group. In addition, the one or two periodic CSI-RS resources in the second group may have same symbol location as the first and/or second CSI-RS resources (or the first one or two CSI-RS resources in the first slot) in the first group.

In some embodiments, an antenna port with a same port index of configured reference signal resources in the at least one set of periodic reference signal resources for the TDCP report. For example, the terminal device 110 may assume the antenna port with the same port index of the configured X CSI-RS resources in the set of periodic TRS is the same.

In some other embodiments, if the QCL assumption for TRS resources configured for one TDCP reporting is not aligned/different, the TDCP reporting will be dropped or not updated. For example, for a CSI-RS resource associated with a NZP-CSI-RS-ResourceSet with the higher layer parameter repetition set to ‘on’, the UE shall not expect to be configured with CSI-RS over the symbols during which the UE is also configured to monitor the CORESET, while for other NZP-CSI-RS-ResourceSet configurations, if the UE is configured with a CSI-RS resource and a search space set associated with a CORESET in the same OFDM symbol(s), the UE may assume that the CSI-RS and a PDCCH DM-RS transmitted in all the search space sets associated with CORESET are quasi co-located with ‘typeD’, if ‘typeD’ is applicable.

In some embodiments, at least one of the at least one set of reference signal resources configured for the TDCP report may be configured with TDCP information. Alternatively, at least one of the at least one set of reference signal resources configured for the TDCP report may be configured with tracking reference signal information. For example, for any embodiments described in the present disclosure, at least one of the at least one CSI-RS resource set configured for TDCP reporting may be configured with tdcp-info (or with additional trs-info).

In some embodiments, the at least one CSI-RS resource set may comprise a first periodic TRS set and at least one second TRS set (periodic or aperiodic), the first periodic TRS set may be configured with trs-info, and the at least one second TRS set may be configured with ‘tdcp-info’ or ‘tdcp-info+trs-info’. Alternatively, or in addition, the at least one CSI-RS resource set may be aperiodic TRS set, the at least one CSI-RS resource set may be configured with ‘tdcp-info’ or ‘tdcp-info+trs-info’. In some embodiments, the at least one CSI-RS resource set configured for TDCP reporting may be associated/configured with a reportConfig, where the reportConfig comprises reportQuantity configured with ‘tdcp’. The first CSI-RS resource set may be configured with ‘trs-info’, and the terminal device may apply the first CSI-RS resource set for tracking. In some embodiments, for the CSI-RS resource configured with ‘tdcp-info’ or ‘tdcp-info+trs-info’, the CSI-RS resource may not be configured as QCL source/reference RS or may not be associated with reportQuantity set to ‘none’ or ‘tdcp’, and for the CSI-RS resource configured with ‘tdcp-info’ or ‘tdcp-info+trs-info’, the CSI-RS resource configuration follows at least one embodiments of ([0093]-[00101]). In addition, the at least one CSI-RS resource set configured for one TDCP reporting may be assumed to be associated with the serving cell or associated with a same PCI value (if the PCI is different from the serving cell).

In some embodiments, a UE (i.e., the terminal device 110) does not expect to be configured with a CSI-ReportConfig that is linked to a CSI-ResourceConfig containing an NZP-CSI-RS-ResourceSet configured with trs-Info or tdcp-Info and with the CSI-ReportConfig configured with the higher layer parameter time RestrictionForChannelMeasurements set to ‘configured’. In some embodiments, a UE expects to be configured with a CSI-ReportConfig that is linked to a CSI-ResourceConfig containing an NZP-CSI-RS-ResourceSet configured with tdcp-Info and with the CSI-ReportConfig configured with the higher layer parameter time RestrictionForChannelMeasurements set to ‘configured’.

In some embodiments, a UE does not expect to be configured with a CSI-ReportConfig with the higher layer parameter reportQuantity set to other than ‘none’ or ‘tdcp’ for aperiodic NZP CSI-RS resource set configured with trs-Info and/or tdcp-Info. In some other embodiments, a UE does not expect to be configured with a CSI-ReportConfig with the higher layer parameter reportQuantity set to other than ‘none’ or ‘tdcp’ for NZP CSI-RS resource set configured with tdcp-Info.

In some other embodiments, a UE does not expect to be configured with a CSI-ReportConfig for periodic NZP CSI-RS resource set configured with trs-Info and not configured with tdcp-Info. In some embodiments, a UE does not expect to be configured with a NZP-CSI-RS-ResourceSet configured with any two of trs-Info, tdcp-Info and repetition. In some embodiments, a UE does not expect to be configured with a NZP-CSI-RS-ResourceSet configured with tdcp-Info and repetition.

In some embodiments, a quantization step size is associated with a value of delay or number of delays. For example, quantization step size and/or number of bits for quantization and/or range for quantization may be associated with (or correspond to or based on) the value(s) of delay and/or number of delays (e.g. Y). Alternatively, a number of correlations and/or a value of delay is associated with the number of delays. For example, number of correlations and/or the value(s) of delay may be associated with (or correspond to or based on) the number of delays.

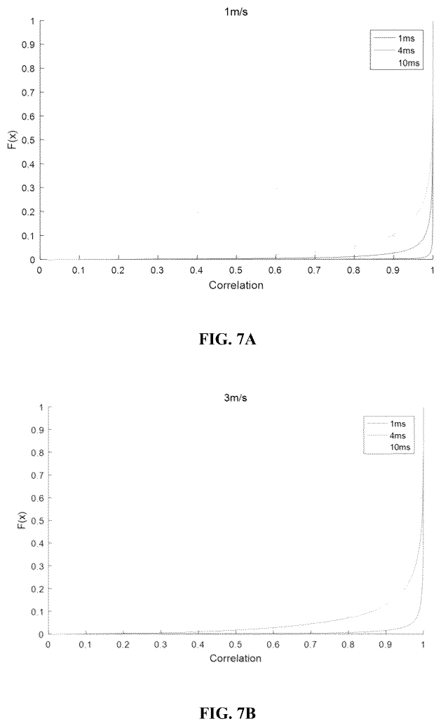

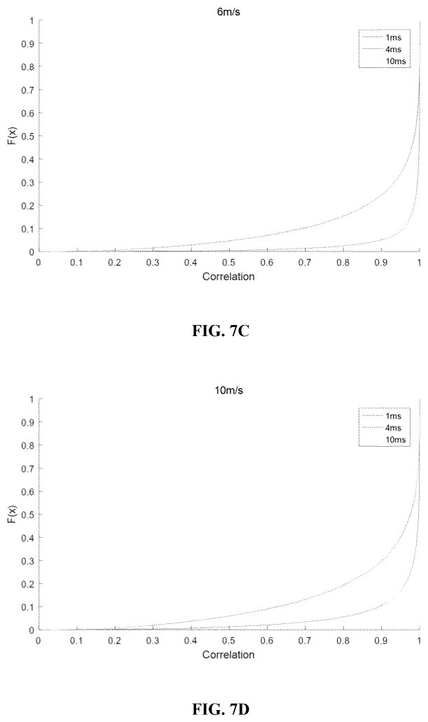

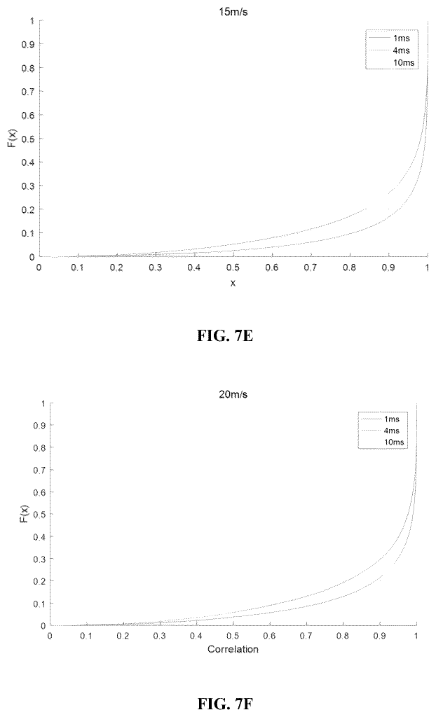

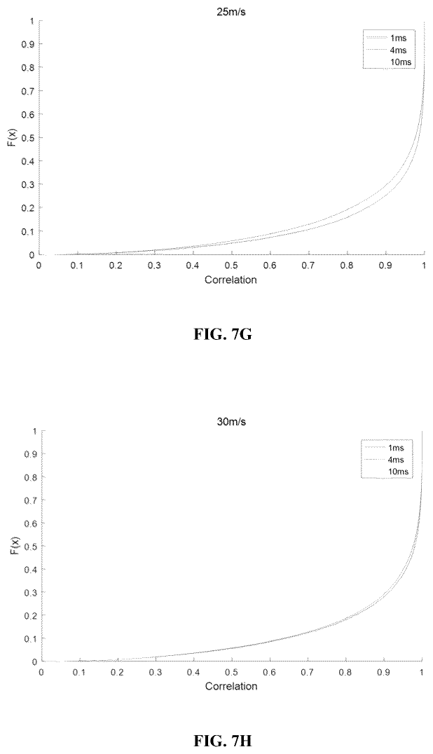

By way of example, in case of Y=1 (or for D_basic or for the first correlation), the candidate values for delay may be 14 symbols (or 1 slot), 12 symbols, 8 symbols, 9 symbols, 2 slots. Otherwise (e.g. Y>1 or for the other correlation excluding the first one), the candidate values for delay may be 1 slot, 2 slots, 4 slots, 5 slots, 8 slots, 10 slots. In this case, the candidate values for delay(s) may be based on subcarrier spacing or based on 15 kHz (the candidate values for SCS with index u may be multiplied by 24). For example, the SCS value may be 15*2^{μ} kHz. FIG. 7A to FIG. 7H show examples for CDF of values of correlation in case of difference speed, where FIG. 7A shows an example where the speed is 1 m/s, FIG. 7B shows an example where the speed is 3 m/s, FIG. 7C shows an example where the speed is 6 m/s, FIG. 7D shows an example where the speed is 10 m/s, FIG. 7E shows an example where the speed is 15 m/s, FIG. 7F shows an example where the speed is 20 m/s, FIG. 7G shows an example where the speed is 25 m/s, and FIG. 7H shows an example where the speed is 30 m/s.

In some embodiments, if the number of delays is 1 (or for the first correlation), (e.g. for codebook switching, the delay may not be too small, and the number of bits for quantization is not needed to be too many, and/or the range may be limited, e.g. [0.85-1] or [0.9-1]). Table 3 below shows examples of values of the correlations. In some embodiments, at least one row of Table 3 may be applied for the range of TDCP reporting.

TABLE 3
Example Values

0.98
0.96
0.94
0.93
0.92
0.9
0.8
0.7

In some embodiments, within the range of TDCP reporting (For example, the range may be [RA3-RA2]), there may be a first number of values within the range of [RA2-RA1], and there may be a second number of values within the range of [RA3-RA2], and the first number is larger than the second number. In some embodiments, RA3 may be a decimal with 0.5<=RA3<=0.8. For example, RA3 may be at least one of {0.5, 0.6, 0.65, 0.7, 0.75, 0,8}. In some embodiments, RA2 may be a decimal with 0.8<=RA2<=0.93. For example, RA2 may be at least one of {0,8, 0.81, 0.82, 0.83, 0.84, 0.85, 0.86, 0.87, 0.88, 0.89, 0.9, 0.91, 0.92, 0.93}. In some embodiments, RA1 may be a decimal with 0.93<=RA2<=1. For example, RA1 may be at least one of {0,93, 0.94, 0.95, 0.96, 0.97, 0.98, 0.986, 0.99, 0.992, 0.994, 0.996, 0.998, 0.999, 1}.

In some embodiments, within the range of TDCP reporting, there may be a first number of values within the range of [0.9-1] or [0.85-1], and there may be a second number of values within the range of [0.7-0.9] or [0.7-0.85] or [0.5-0.9] or [0.5-0.85], and the first number is larger than the second number.

In some embodiments, the candidate values of delay may be N slots, where N may be at least one of {1,2,3,4,5}. A first number of quantization bits (e.g. with small value) and/or a first range may be applied, for example, 1 or 2 or 3 bits. For example, the step size for quantization corresponding to one delay (Y=1) may be non-uniform, where a first range ([RA12-RA11], e.g. [0.9-1], a first step size may be applied, and within a second range ([RA13-RA12], e.g. 0.7-0.9), a second step size may be applied, and the second step size is larger than the first step size. For example, (if no two consecutive slots are indicated as downlink slots by tdd-UL-DL-ConfigurationCommon or tdd-UL-DL-ConfigDedicated), if there are only two CSI-RS resources in one slot for a periodic set of TRS, a second aperiodic set of TRS (comprising one CSI-RS resource) may be in the same slot as the periodic set of TRS, and the CSI-RS resource may be on the first symbol or the last symbol, and in this case the delay may be 8 or 9 symbols (e.g. D_basic=14 symbols). If CSI-RS resource in the periodic set of TRS is {4, 8}, the CSI-RS resource in the second aperiodic set is on last symbol in the same slot, delay is 9 symbols. If CSI-RS resource in the periodic set of TRS is {5, 9}, the CSI-RS resource in the second aperiodic set is on first or last symbol in the same slot, delay is 8 symbols. If CSI-RS resource in the periodic set of TRS is {6, 10}, the CSI-RS resource in the second aperiodic set is on first symbol in the same slot, delay is 9 symbols. In some embodiments, RA11 may be a decimal with 0.8<=RA11<=1. In some embodiments, RA12 may be a decimal with 0.5<=RA12<=1. In some embodiments, RA13 may be a decimal with 0.5<=RA13<=1. In some embodiments, RA12 may be less than RA11. In some embodiments, RA13 may be less than RA12.

In some embodiments, for Y>1 (or for the other correlation excluding the first one), the number of bits for quantization may be larger than that for Y=1. For example, the range ([RA22-RA21]) may correspond to or be associated with the value of delay for the correlation. In some embodiments, RA22<RA13 or RA22<RA12. Alternatively, the number of bits may be 3 or 4. As Y=1 may be applied for codebook switching/RS periodicity switching. In some embodiments, RA21 may be a decimal with 0.8<=RA21<=1. In some embodiments, RA22 may be a decimal with 0.5<=RA22<=1. In some embodiments, RA22 may be less than RA21.

In some embodiments, when phase is present, the number of bits for quantization may be larger than that for phase is present and/or the step size for quantization may be smaller than that for phase is absent. As if phase is present, it may be applied for channel predication, more information is needed. For example, in case of Y>1, for the first correlation, 1 or 2 or 3 bits may be applied for reporting, and for the second correlation, 3 or 4 bits may be applied for reporting. For example, in case of Y>1, the number of bits and/or range for the first correlation may be larger than the number of bits and/or range for the correlation in case of Y=1. For example, in case of Y>1, the correlation excluding the first one may be differential value related to the first correlation value, and 1 or 2 or 3 bits may be applied. For example, the candidate values may be at least one of {0, 0.1, 0.2, >=0.3} or {0, 0.05, 0.1, 0.15, 0.2, 0.25, 0.3, >=0.35}.

In some embodiments, the priority for TDCP reporting may be lower than other CSI report(s). For example, the priority for the first correlation (e.g. corresponding to the first delay) may have higher than the priority for the other correlations excluding the first correlation (e.g. in case of Y>1). An example for TS update (lower than other CSI report(s) with same time domain behavior) may be shown in Table 4.

```
TABLE 4
CSI reports are associated with a priority value Pri_{iCSI}(y, k, c, s) = 3 ·
N_{cells} · Mₛ · y + N_{cells} · Mₛ · k + Mₛ · c + s where
- y = 0 for aperiodic CSI reports to be carried on PUSCH, y = 1 for
semi-persistent CSI reports to be carried on PUSCH, y = 2 for semi-
persistent CSI reports to be carried on PUCCH and y = 3 for periodic
CSI reports to be carried on PUCCH;
- k = 0 for CSI reports carrying L1-RSRP or L1-SINR, k = 1 for CSI
reports not carrying L1-RSRP or L1-SINR or TDCP, and k = 2 for CSI
reports carrying TDCP ;
  - c is the serving cell index and N_{cells} is the value of the higher layer
    parameter maxNrofServingCells;
  - s is the reportConfigID and is the value of the higher layer parameter
    maxNrofCSI-ReportConfigurations.
A first CSI report is said to have priority over second CSI report if the
associated value is lower for the first report than for the second report.
```

An example for TS update (lower than other CSI report(s) regardless of time domain behaviour) may be shown in Table 5.

```
TABLE 5
CSI reports are associated with a priority value Pri_{iCSI}(y, k, c, s) = 2 ·
N_{cells} · Mₛ · y + N_{cells} · Mₛ · k + Mₛ · c + s where
- y = 0 for aperiodic CSI reports not carrying TDCP to be carried on
PUSCH, y = 1 for semi-persistent CSI reports not carrying TDCP to
be carried on PUSCH,
y = 2 for semi-persistent CSI reports not carrying TDCP to be carried on
PUCCH,
y = 3 for periodic CSI reports not carrying TDCP to be carried on
PUCCH, and y = 4 for CSI reports carrying TDCP;
- k = 0 for CSI reports carrying L1-RSRP or L1-SINR and k = 1 for CSI
reports not carrying L1-RSRP or L1-SINR;
  - c is the serving cell index and N_{cells} is the value of the higher layer
    parametermaxNrofServingCells;
  - s is the reportConfigID and is the value of the higher layer parameter
    maxNrofCSI-ReportConfigurations.
A first CSI report is said to have priority over second CSI report if the
associated value is lower for the first report than for the second report.
```

An example for TS update (lower than other CSI report(s) regardless of time domain behaviour) may be shown in Table 6.

```
TABLE 6
CSI reports are associated with a priority value Pri_{iCSI}(y, k, c, s) = 2 ·
N_{cells} · Mₛ · y + N_{cells} · Mₛ · k + Mₛ · c + s where
- y = 0 for aperiodic CSI reports to be carried on PUSCH, y = 1 for
semi-persistent CSI reports to be carried on PUSCH, y = 2 for semi-
persistent CSI reports to be carried on PUCCH and y = 3 for periodic
CSI reports to be carried on PUCCH;
- k = 0 for CSI reports carrying L1-RSRP or L1-SINR, k = 1 for CSI
reports not carrying L1-RSRP or L1-SINR or TDCP and k = 8 (or k =
3 · y + 2 or k = 2 · y + 2) for CSI reports carrying TDCP ;
  - c is the serving cell index and N_{cells} is the value of the higher layer
    parameter maxNrofServingCells;
  - s is the reportConfigID and is the value of the higher layer
    parameter maxNrofCSI-ReportConfigurations.
A first CSI report is said to have priority over second CSI report if the
associated value is lower for the first report than for the second report.
```

FIG. 8 illustrates a flowchart of a communication method 800 implemented at a terminal device in accordance with some embodiments of the present disclosure. For example, the method 800 may be implemented by the terminal device 110 in FIG. 1B.

At block 810, the terminal device 110 receives, from the network device 120, information that indicates at least one set of reference signal resources for a time domain channel property (TDCP) report. In some embodiments, the information indicates a first set of reference signal resources and at least one second set of reference signal resources for the TDCP report.

At block 820, the terminal device 110 transmits the TDCP report to the terminal device 110. The TDCP report comprises one or more of: at least one amplitude or at least one phase of a correlation between a first reference signal resource and another reference signal resource. If the TDCP report comprises a plurality of amplitudes and/or a plurality of phases, the plurality of amplitudes and/or the plurality of phases is based on correlations between the first reference signal resource and a plurality of second reference signal resources. The reference signal resource is the first one in a first set of reference signal resources or one reference signal resource in a last set of reference signal resources.

In some embodiments, the first set of reference signal resources is a first set of periodic reference signal resources and the at least one second set of reference signal resources is at least one set of aperiodic reference signal resources. In some embodiments, each one of the at least one set of aperiodic reference signal resources comprises one or two aperiodic reference signal resources in one slot, and the one or two aperiodic reference signal resources have same subcarrier location as reference signal resources in the first set of periodic reference signal resources.

In some embodiments, a triggering offset indicates a slot offset between a first slot of one occasion in the first set of periodic reference signal resources and a slot for the at least one aperiodic set of reference signal resources. In some embodiments, the triggering offset indicates the slot offset between a second slot of one occasion in the first set of periodic reference signal resources and the slot for the at least one aperiodic set of reference signal resources.

In some embodiments, each one of the at least one set of aperiodic reference signal resources comprises two or four aperiodic reference signal resources in two consecutive slots, and one or two aperiodic reference signal resources in one slot, and the two or four aperiodic reference signal resources have same subcarrier location as the reference signal resources in the first set of periodic reference signal resources. In some embodiments, each one of the at least one set of aperiodic reference signal resources is associated with the first set of periodic reference signal resources.

In some embodiments, the aperiodic reference signal resource is configured with qcl-Type set to ‘typeA’ (For example, except for quasi co-location parameters {Doppler shift, Doppler spread}) and/or ‘typeD’, with the periodic reference signal resources in the first set. In some embodiments, an antenna port with a same port index of configured reference signal resources in the at least one set of aperiodic reference signal resources and in the first set of periodic reference signal resources is the same.

In some embodiments, the aperiodic reference signal resource in the at least one set of aperiodic reference signal resources is configured with qcl-Type set to ‘typeC’ (For example, except for quasi co-location parameters {Doppler shift}) and/or ‘typeD’ with a same synchronization signal physical broadcast channel block (SSB) index or a same reference signal resource with quasi colocation (QCL) source reference signal of reference signal resources in the first set of periodic reference signal resources. In some embodiments, a triggering offset indicates a slot offset between downlink control information and a slot for the at least one aperiodic set of reference signal resources. In some embodiments, the offset between the slot for the at least one aperiodic set of reference signal resources and a first or second slot of an occasion of the first set of periodic reference signal resources is one of candidate values for delays supported for the TDCP report.

In some embodiments, the first set of reference signal resources is a first set of aperiodic reference signal resources and the at least one second set of reference signal resources is at least one set of aperiodic reference signal resources. In some embodiments, each set of aperiodic reference signal resources comprises one or two aperiodic reference signal resources in one slot, and the aperiodic reference signal resources have same subcarrier location in the at least one set of aperiodic reference signal resources. In some embodiments, the at least one set of aperiodic reference signal resource is associated with a same periodic reference signal resource set. In some embodiments, a triggering for the first set indicates a first slot offset between DCI and a slot for the first set, and the triggering offset for the second set indicates a second slot offset between the slot of the first set and a slot for the second set, candidate values for the second slot offset are candidate values for delay for the TDCP report.

In some embodiments, the triggering offset for each set of reference signal resources indicates a slot offset between DCI and a slot for a corresponding set, and candidate values for the slot offset are candidate values for delay for the TDCP report. In some embodiments, the offset between a slot for the second set and a slot of the first set may be one of the candidate values for delays supported for the TDCP report.

In some embodiments, the first set of reference signal resources is a first set of periodic reference signal resources and the at least one second set of reference signal resources is a second set of periodic reference signal resources. In some embodiments, the second set of periodic reference signal resources comprises one or two aperiodic reference signal resources in one slot, and one or two periodic reference signal resources have same subcarrier location as the reference signal resources in the first set of periodic reference signal resources. In some embodiments, the second set of periodic reference signal resources is associated with the first set of periodic reference signal resources.

In some embodiments, the information indicates at least one set of periodic reference signal resources for the TDCP report. In some embodiments, one or two periodic reference signal resources in a second group of the at least one set of periodic reference signal resources for the TDCP report have same subcarrier location as reference signal resources in a first group of the at least one set of periodic reference signal resources for the TDCP report. In some embodiments, an antenna port with a same port index of configured reference signal resources in the at least one set of periodic reference signal resources for the TDCP report.

In some embodiments, at least one of the at least one set of reference signal resources configured for the TDCP report is configured with TDCP information. In some embodiments, at least one of the at least one set of reference signal resources configured for the TDCP report is configured with tracking reference signal information.

In some embodiments, a quantization step size is associated with a value of delay or number of delays. In some embodiments, a number of correlations and/or a value of delay is associated with the number of delays.

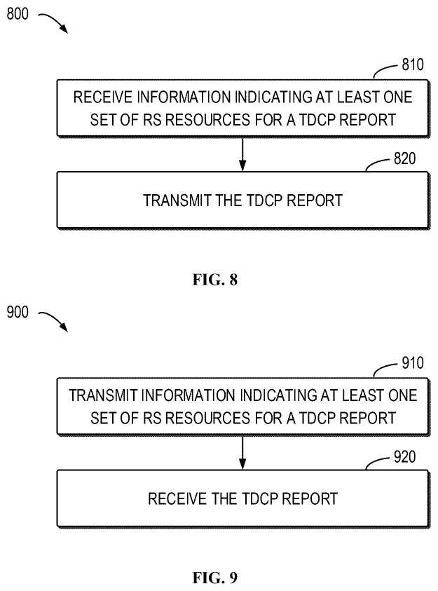

FIG. 9 illustrates a flowchart of a communication method 900 implemented at a network device in accordance with some embodiments of the present disclosure. For example, the method 900 may be implemented by the network device 120 in FIG. 1B.

At block 910, the network device 120 transmits, to the terminal device 110, information that indicates at least one set of reference signal resources for a time domain channel property (TDCP) report. In some embodiments, the information indicates a first set of reference signal resources and at least one second set of reference signal resources for the TDCP report.

At block 920, the network device 120 receives the TDCP report from the terminal device 110. The TDCP report comprises one or more of: at least one amplitude or at least one phase of a correlation between a first reference signal resource and another reference signal resource. If the TDCP report comprises a plurality of amplitudes and/or a plurality of phases, the plurality of amplitudes and/or the plurality of phases is based on correlations between the first reference signal resource and a plurality of second reference signal resources. The first reference signal resource is the first one in a first set of reference signal resources or one reference signal resource in a last set of reference signal resources.

In some embodiments, the first set of reference signal resources is a first set of periodic reference signal resources and the at least one second set of reference signal resources is at least one set of aperiodic reference signal resources. In some embodiments, the first set of reference signal resources is a first set of aperiodic reference signal resources and the at least one second set of reference signal resources is at least one set of aperiodic reference signal resources. In some embodiments, the first set of reference signal resources is a first set of periodic reference signal resources and the at least one second set of reference signal resources is a second set of periodic reference signal resources. In some embodiments, the information indicates at least one set of periodic reference signal resources for the TDCP report.

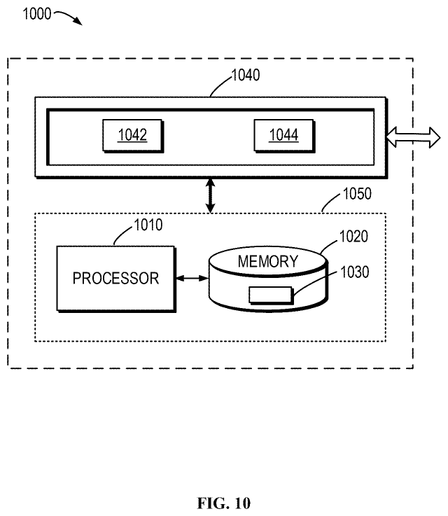

FIG. 10 is a simplified block diagram of a device 1000 that is suitable for implementing embodiments of the present disclosure. The device 1000 can be considered as a further example implementation of any of the devices as shown in FIG. 1B. Accordingly, the device 1000 can be implemented at or as at least a part of the terminal device 110 or the network device 120.

As shown, the device 1000 includes a processor 1010, a memory 1020 coupled to the processor 1010, a suitable transceiver 1040 coupled to the processor 1010, and a communication interface coupled to the transceiver 1040. The memory 1010 stores at least a part of a program 1030. The transceiver 1040 may be for bidirectional communications or a unidirectional communication based on requirements. The transceiver 1040 may include at least one of a transmitter 1042 and a receiver 1044. The transmitter 1042 and the receiver 1044 may be functional modules or physical entities. The transceiver 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 4. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 10100 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: receive, from a network device, information that indicates at least one set of reference signal resources for a time domain channel property (TDCP) report; and transmit the TDCP report, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In some embodiments, a network device comprises a circuitry configured to: transmit, to a terminal device, information that indicates at least one set of reference signal resources for a time domain channel property (TDCP) report; and receive the TDCP report, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

According to embodiments of the present disclosure, the circuitry may be configured to perform any of the method implemented by the device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In an aspect, a terminal device, comprises: a processor, configured to cause the terminal device to: receive, from a network device, information that indicates at least one set of reference signal resources for a time domain channel property (TDCP) report; and transmit the TDCP report to the network device, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In some solutions, the information indicates a first set of reference signal resources and at least one second set of reference signal resources for the TDCP report.

In some solutions, the first set of reference signal resources is a first set of periodic reference signal resources and the at least one second set of reference signal resources is at least one set of aperiodic reference signal resources.

In some solutions, each one of the at least one set of aperiodic reference signal resources comprises one or two aperiodic reference signal resources in one slot, and the one or two aperiodic reference signal resources have same subcarrier location as reference signal resources in the first set of periodic reference signal resources.

In some solutions, a triggering offset indicates a slot offset between a first slot of one occasion in the first set of periodic reference signal resources and a slot for the at least one aperiodic set of reference signal resources, or wherein the triggering offset indicates the slot offset between a second slot of one occasion in the first set of periodic reference signal resources and the slot for the at least one aperiodic set of reference signal resources.

In some solutions, each one of the at least one set of aperiodic reference signal resources comprises two or four aperiodic reference signal resources in two consecutive slots, and one or two aperiodic reference signal resources in one slot, and the two or four aperiodic reference signal resources have same subcarrier location as the reference signal resources in the first set of periodic reference signal resources.

In some solutions, each one of the at least one set of aperiodic reference signal resources is associated with the first set of periodic reference signal resources.

In some solutions, the aperiodic reference signal resource is configured with qcl-Type set to ‘typeA’ (For example, except for quasi co-location parameters {Doppler shift, Doppler spread}) and/or ‘typeD’, with the periodic reference signal resources in the first set.

In some solutions, an antenna port with a same port index of configured reference signal resources in the at least one set of aperiodic reference signal resources and in the first set of periodic reference signal resources is the same.

In some solutions, the aperiodic reference signal resource in the at least one set of aperiodic reference signal resources is configured with qcl-Type set to ‘typeC’ (For example, except for quasi co-location parameters {Doppler shift}) and/or ‘typeD’ with a same synchronization signal physical broadcast channel block (SSB) index or a same reference signal resource with quasi colocation (QCL) source reference signal of reference signal resources in the first set of periodic reference signal resources.

In some solutions, a triggering offset indicates a slot offset between downlink control information and a slot for the at least one aperiodic set of reference signal resources, and wherein the offset between the slot for the at least one aperiodic set of reference signal resources and a first or second slot of an occasion of the first set of periodic reference signal resources is one of candidate values for delays supported for the TDCP report.

In some solutions, the first set of reference signal resources is a first set of aperiodic reference signal resources and the at least one second set of reference signal resources is at least one set of aperiodic reference signal resources.

In some solutions, each set of aperiodic reference signal resources comprises one or two aperiodic reference signal resources in one slot, and the aperiodic reference signal resources have same subcarrier location in the at least one set of aperiodic reference signal resources.

In some solutions, the at least one set of aperiodic reference signal resource is associated with a same periodic reference signal resource set.

In some solutions, a triggering offset for the first set indicates a first slot offset between DCI and a slot for the first set, and the triggering offset for the second set indicates a second slot offset between the slot of the first set and a slot for the second set, candidate values for the second slot offset are candidate values for delay for the TDCP report.

In some solutions, the triggering offset for each set of reference signal resources indicates a slot offset between DCI and a slot for a corresponding set, and candidate values for the slot offset are candidate values for delay for the TDCP report, and wherein the offset between a slot for the second set and a slot of the first set may be one of the candidate values for delays supported for the TDCP report.

In some solutions, the first set of reference signal resources is a first set of periodic reference signal resources and the at least one second set of reference signal resources is a second set of periodic reference signal resources.

In some solutions, the second set of periodic reference signal resources comprises one or two aperiodic reference signal resources in one slot, and one or two periodic reference signal resources have same subcarrier location as the reference signal resources in the first set of periodic reference signal resources.

In some solutions, the second set of periodic reference signal resources is associated with the first set of periodic reference signal resources.

In some solutions, the information indicates at least one set of periodic reference signal resources for the TDCP report.

In some solutions, one or two periodic reference signal resources in a second group of the at least one set of periodic reference signal resources for the TDCP report have same subcarrier location as reference signal resources in a first group of the at least one set of periodic reference signal resources for the TDCP report.

In some solutions, an antenna port with a same port index of configured reference signal resources in the at least one set of periodic reference signal resources for the TDCP report.

In some solutions, at least one of the at least one set of reference signal resources configured for the TDCP report is configured with TDCP information, or wherein at least one of the at least one set of reference signal resources configured for the TDCP report is configured with tracking reference signal information.

In some solutions, a quantization step size is associated with a value of delay or number of delays.

In some solutions, a number of correlations and/or a value of delay is associated with the number of delays.

In an aspect, a network device, comprises: a processor, configured to cause the network device to: transmit, to a terminal device, information that indicates at least one set of reference signal resources for a time domain channel property (TDCP) report; and receive the TDCP report from the terminal device, wherein the TDCP report comprises one or more of: at least one amplitude or at least one phase of a correlation between a first reference signal resource and another reference signal resource, wherein if the TDCP report comprises a plurality of amplitudes and/or a plurality of phases, the plurality of amplitudes and/or the plurality of phases is based on correlations between the first reference signal resource and a plurality of second reference signal resources, and wherein the first reference signal resource is the first one in a first set of reference signal resources or one reference signal resource in a last set of reference signal resources.

In some solutions, the information indicates a first set of reference signal resources and at least one second set of reference signal resources for the TDCP report.

In some solutions, the first set of reference signal resources is a first set of periodic reference signal resources and the at least one second set of reference signal resources is at least one set of aperiodic reference signal resources.

In some solutions, the first set of reference signal resources is a first set of aperiodic reference signal resources and the at least one second set of reference signal resources is at least one set of aperiodic reference signal resources.

In some solutions, the first set of reference signal resources is a first set of periodic reference signal resources and the at least one second set of reference signal resources is a second set of periodic reference signal resources.

In some solutions, the information indicates at least one set of periodic reference signal resources for the TDCP report.

In an aspect, a computer readable medium having instructions stored thereon, the instructions, when executed on at least one processor, causing the at least one processor to perform the method implemented by the device discussed above.

In an aspect, a computer program comprising instructions, the instructions, when executed on at least one processor, causing the at least one processor to perform the method implemented by the device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
a processor, configured to cause the terminal device to:
receive, from a network device, first information related to reference signal resource set list for a time domain channel property (TDCP) and second information related to a delay value; and
transmit a TDCP report to the network device, wherein the TDCP report comprises a parameter related to a correlation between a first set of reference signal resources and a second set of reference signal resources, the parameter being quantized in an amplitude, wherein
the first set of reference signal resources and the second set of reference signal resources are comprised in the reference signal resource set list and
the first set of reference signal resources and the second set of reference signal resources are separated by a value determined on the delay value.

2. (canceled)

3. The terminal device of claim 1, wherein the first set of reference signal resources is a first set of periodic reference signal resources and the at least one second set of reference signal resources is at least one set of aperiodic reference signal resources.

4. The terminal device of claim 3, wherein each one of the at least one set of aperiodic reference signal resources comprises one or two aperiodic reference signal resources in one slot, and the one or two aperiodic reference signal resources have same subcarrier location as reference signal resources in the first set of periodic reference signal resources.

5. The terminal device of claim 4, wherein a triggering offset indicates a slot offset between a first slot of one occasion in the first set of periodic reference signal resources and a slot for the at least one aperiodic set of reference signal resources, or wherein the triggering offset indicates the slot offset between a second slot of one occasion in the first set of periodic reference signal resources and the slot for the at least one aperiodic set of reference signal resources.

6. The terminal device of claim 3, wherein each one of the at least one set of aperiodic reference signal resources comprises two or four aperiodic reference signal resources in two consecutive slots, and one or two aperiodic reference signal resources in one slot, and the two or four aperiodic reference signal resources have same subcarrier location as the reference signal resources in the first set of periodic reference signal resources.

7. The terminal device of claim 6, wherein each one of the at least one set of aperiodic reference signal resources is associated with the first set of periodic reference signal resources.

8. The terminal device of claim 7, wherein the aperiodic reference signal resource is configured with qcl-Type set to ‘typeA’ (except for quasi co-location parameters {Doppler shift, Doppler spread}) and/or ‘typeD’, with the periodic reference signal resources in the first set.

9. The terminal device of claim 7, wherein an antenna port with a same port index of configured reference signal resources in the at least one set of aperiodic reference signal resources and in the first set of periodic reference signal resources is the same.

10. The terminal device of claim 7, wherein the aperiodic reference signal resource in the at least one set of aperiodic reference signal resources is configured with qcl-Type set to ‘typeC’ except for quasi co-location parameters {Doppler shift}, and/or ‘typeD’ with a same synchronization signal physical broadcast channel block (SSB) index or a same reference signal resource with quasi colocation (QCL) source reference signal of reference signal resources in the first set of periodic reference signal resources.

11. The terminal device of claim 6, wherein a triggering offset indicates a slot offset between downlink control information and a slot for the at least one aperiodic set of reference signal resources, and
wherein the offset between the slot for the at least one aperiodic set of reference signal resources and a first or second slot of an occasion of the first set of periodic reference signal resources is one of candidate values for delays supported for the TDCP report.

12. The terminal device of claim 1, wherein the first set of reference signal resources is a first set of aperiodic reference signal resources and the at least one second set of reference signal resources is at least one set of aperiodic reference signal resources.

13. The terminal device of claim 12, wherein each set of aperiodic reference signal resources comprises one or two aperiodic reference signal resources in one slot, and the aperiodic reference signal resources have same subcarrier location in the at least one set of aperiodic reference signal resources.

14. The terminal device of claim 12, wherein the at least one set of aperiodic reference signal resource is associated with a same periodic reference signal resource set.

15. The terminal device of claim 12, wherein a triggering offset for the first set indicates a first slot offset between DCI and a slot for the first set, and the triggering offset for the second set indicates a second slot offset between the slot of the first set and a slot for the second set, candidate values for the second slot offset are candidate values for delay for the TDCP report.

16. The terminal device of claim 12, wherein the triggering offset for each set of reference signal resources indicates a slot offset between DCI and a slot for a corresponding set, and candidate values for the slot offset are candidate values for delay for the TDCP report, and
wherein the offset between a slot for the second set and a slot of the first set may be one of the candidate values for delays supported for the TDCP report.

17. The terminal device of claim 1, wherein at least one of the at least one set of reference signal resources configured for the TDCP report is configured with TDCP information, or
wherein at least one of the at least one set of reference signal resources configured for the TDCP report is configured with tracking reference signal information.

18. The terminal device of claim 1, wherein a quantization step size is associated with a delay value or number of delays.

19. The terminal device of claim 1, wherein a number of correlations and/or a delay value is associated with the number of delays.

20. A network device, comprising:
a processor, configured to cause the network device to:
transmit, to a terminal device, first information related to reference signal resource set list for a time domain channel property (TDCP) and second information related to a delay value; and
receive a TDCP report from the terminal device, wherein the TDCP report comprises a parameter related to a correlation between a first set of reference signal resources and a second set of reference signal resources, the parameter being quantized in an amplitude, wherein
the first set of reference signal resources and the second set of reference signal resources are comprised in the reference signal resource set list; and
the first set of reference signal resources and the second set of reference signal resources are separated by a value determined based on the delay value.

21. The terminal device of claim 1, wherein
the parameter is quantized in the amplitude and a phase.

22. The terminal device of claim 1, wherein
the first set of reference signal resources and the second set of reference signal resources are transmitted on two symbols separated by the value.

23. A method performed by a terminal device, the method comprising:
receiving, from a network device, first information related to reference signal resource set list for a time domain channel property (TDCP) and second information related to a delay value; and
transmitting a TDCP report to the network device, wherein the TDCP report comprises a parameter related to a correlation between a first set of reference signal resources and a second set of reference signal resources, the parameter being quantized in an amplitude, wherein
the first set of reference signal resources and the second set of reference signal resources are comprised in the reference signal resource set list; and
the first set of reference signal resources and the second set of reference signal resources are separated by a value determined based on the delay value.
